(19) United States
(12) Patent Application Publication
(10) Pub. No.: US 2025/0142402 A1
(43) Pub. Date: May 1, 2025

(54) METHOD FOR PROCESSING DATA, AND DEVICE

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN); Xin YOU, Dongguan (CN); Cong SHI, Dongguan (CN)

(21) Appl. No.: 19/004,634

(22) Filed: Dec. 30, 2024

Related U.S. Application Data
(63) Continuation of application No. PCT/CN2022/105279, filed on Jul. 12, 2022.

(51) Int. Cl. H04W 28/02

(52) U.S. Cl. CPC H04W 28/0268

(57) ABSTRACT

Provided is a method for processing data. The method includes: independently processing and/or jointly processing different data corresponding to a same quality of service (QOS) flow. The method is applicable to a communication device, the communication device includes a processor and a memory storing one or more computer programs, wherein the processor, when loading and running the one or more computer programs, is caused to perform the method.

### CROSS-REFERENCE TO RELATED APPLICATION

This application is a continuation application of international application No. PCT/CN2022/105279, filed on Jul. 12, 2022, the entire contents of which are incorporated herein by reference.

### TECHNICAL FIELD

Embodiments of the present disclosure relate to the technical field of communications, and in particular, relate to a method and apparatus for processing data, and a device, a storage medium and a program product thereof.

### BACKGROUND

In the related art, data is processed based on a quality of service (QOS) flow or a session granularity, the protocol data unit (PDU) sets of the same QoS flow or the same session granularity are processed without distinction. This approach fails to satisfy actual needs in special scenarios.

### SUMMARY

Embodiments of the present disclosure provide a method for processing data, and a device. The technical solutions are as follows.

According to some embodiments of the present disclosure, a method for processing data is provided. The method includes:

independently processing and/or jointly processing different data corresponding to a same QoS flow.

According to some embodiments of the present disclosure, a communication device is provided. The communication device includes a processor and a memory storing one or more computer programs, wherein the processor, when loading and running the one or more computer programs, is caused to perform the method for processing data described above.

According to some embodiments of the present disclosure, a communication device is provided. The communication device includes a processor and a memory storing one or more computer programs, wherein the processor, when loading and running the one or more computer programs, is caused to perform: acquiring a first result by measuring and statistically analyzing a protocol data unit (PDU) set.

### BRIEF DESCRIPTION OF THE DRAWINGS

FIG. 1 is a schematic diagram of a network architecture according to some embodiments of the present disclosure;

FIG. 2 is a schematic diagram illustrating data interaction based on a QoS flow according to some embodiments of the present disclosure;

FIG. 3 is a schematic diagram of a radio protocol architecture according to some embodiments of the present disclosure;

FIG. 4 is a flowchart of a method for processing data according to some embodiments of the present disclosure;

FIG. 5 is a schematic diagram of PDCP protocol layer joint processing according to some embodiments of the present disclosure;

FIG. 6 is a schematic diagram of PDCP protocol layer joint processing according to some other embodiments of the present disclosure;

FIG. 7 is a schematic diagram of a method for processing data at a PDCP layer according to some embodiments of the present disclosure;

FIG. 8 is a schematic diagram of a method for processing data at a PDCP layer according to some other embodiments of the present disclosure;

FIG. 9 is a schematic diagram of a method for processing data at a PDCP layer according to some other embodiments of the present disclosure;

FIG. 10 is a schematic diagram of a method for processing data at a PDCP layer according to some other embodiments of the present disclosure;

FIG. 11 is a schematic diagram of a method for processing data at an SDAP layer according to some other embodiments of the present disclosure;

FIG. 12 s a schematic diagram of a method for processing data at an SDAP layer according to some other embodiments of the present disclosure;

FIG. 13 is a flowchart of a method for PDCP reconfiguration according to some embodiments of the present disclosure;

FIG. 14 is a flowchart of a method for PDCP reconfiguration according to some other embodiments of the present disclosure;

FIG. 15 is a flowchart for configuring or changing the mapping relationship between a QoS flow and a path according to some embodiments of the present disclosure;

FIG. 16 is a flowchart of a method for processing data according to some other embodiments of the present disclosure;

FIG. 17 is a block diagram of an apparatus for processing data according to some embodiments of the present disclosure;

FIG. 18 is a block diagram of an apparatus for processing data according to some other embodiments of the present disclosure; and

FIG. 19 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

First, the terms involved in the embodiments of the present disclosure are briefly described hereinafter.

A PDU set is composed of one or more PDUs that bear the payload of an information unit generated at an application layer. For example, the information unit is a frame or a video slice of extended reality and media services (XRMs). The information has the same importance requirements at the application layer. The application layer requires each of the PDUs within the PDU set to use the corresponding information unit. In some cases, the application layer may still restore a portion of the information unit when some of the PDUs are lost. It should be noted that the I-frames, P-frames, and the like mentioned later are merely a representation of the PDU sets.

The I-frame is an intra-coded picture, and the I-frame is a complete picture that may be independently encoded and decoded like a JPG image file.

The P-frame is a predicted picture, and the P-frame is not a complete frame, but only contains image changes as compared with a previous frame. In the case that a reference frame is lost, the P-frame fails to be decoded or displayed.

A B-frame is a bi-directionally predicted picture, and the B-frame contains changes between a previous reference frame and a next reference frame. More reference frames may result in a higher compression ratio. However, the B-frame may only be decoded in the case that the previous reference frame and the next reference frame are available.

A group of pictures (GOP) includes a set of consecutive video frames. A first frame of the GOP is the I-frame and the following frame may be the P-frame or the B-frame.

For example, an association or dependency relationship may be present between the PDUs. For example, a PDU set represents a video frame, and compression and decoding of the video frame may be completed only when all the associated PDUs within the PDU set are received at the same time. Alternatively, compression and decoding of the video frame may be completed upon receipt of indications for some of the PDUs. In addition, an association or dependency relationship may be present between different PDU sets. For example, a dependency relationship is present between a PDU set representing an I-frame and a PDU set representing a P-frame, such that compression and decoding of the P-frame depend on the I-frame.

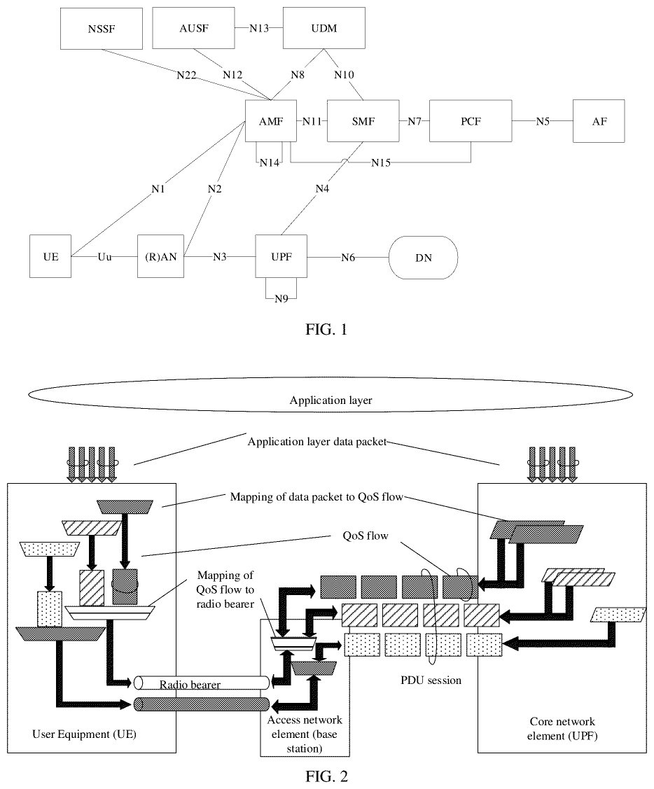

For a 5G network system architecture, referring to FIG. 1, the 5G network system includes: user equipment (UE, naming of a mobile terminal by 3GPP), a (radio) access network ((R)AN), a user plane function (UPF), a data network (DN), and control plane functions.

The control plane functions include: an access and mobility management function (AMF), a session management function (SMF), a policy control function (PCF), unified data management (UDM), an application function (AF), a network slice selection function (NSSF), and an authentication server function (AUSF).

The UE establishes an access stratum connection to the AN over a Uu air interface to implement access stratum messages interaction and wireless data transmission, and the UE establishes a non-access stratum (NAS) connection to the AMF over an N1 interface to implement NAS messages interaction. The AMF is a mobility management function in a core network, the SMF is a session management function in the core network. The AMF is responsible for forwarding messages related to session management between the UE and the SMF in addition to performing mobility management on the UE. The PCF is a policy management function in the core network, and is responsible for formulating policies related to mobility management, session management, charging, and the like for the UE. The UPF is a user plane function in the core network, and performs data transmission with an external data network over an N6 interface and with the AN over an N3 interface.

The concept of QoS flow is introduced into the 5G network. After accessing the 5G network over the Uu air interface, the UE establishes the QoS flow for data transmission under the control of the SMF. The SMF provides QoS flow configuration information of each QoS flow to a base station, and the QoS flow configuration information includes a bit rate requirement, a delay requirement, a bit error rate requirement, and the like. For each QoS flow, the base station schedules, based on the QoS flow configuration information received from the SMF, wireless resources to guarantee the QoS requirements of the QoS flow.

In a QoS flow in the 5G network, an uplink data flow (a data flow transmitted by the UE to a peer device over the 5G network) may be transmitted, and a downlink data flow (a data flow transmitted by the peer device to the UE over the 5G network) may also be transmitted. The peer device refers to a peer application server or a peer UE. The delay requirements of uplink and downlink data flows in a QoS flow are the same. In the case that the delay requirements of uplink and downlink data flows for a service are different, the data flows are transmitted over different QoS flows. The delay here refers to a data transmission delay between the UE and the UPF.

In data processing within 5G networks, the processing requirements for different PDUs or PDU sets are not taken into account, and processing is performed uniformly for different PDUs or PDU sets. As a result, the requirements of different PDUs or PDU sets fail to be satisfied.

Referring to FIG. 2, for transmission of user plane data in a mobile communication network, one or more QoS flows need to be established, and different data flows correspond to different QoS parameters. As an important metric for measuring communication quality, QoS parameters typically indicate the characteristics of a QoS flow. QoS parameters include but are not limited to: a 5G QoS identifier (5QI), allocation and retention priority (ARP), a guaranteed flow bit rate (GFBR), a maximum flow bit rate (MFBR), a maximum packet loss rate (UL, DL), an end-to-end packet delay budget (PDB), an access network PDB (AN-PDB), a packet error rate, a priority level, an averaging window, a resource type, a maximum data burst volume, a user equipment aggregated maximum bit rate (UE-AMBR), a session aggregated maximum bit rate (session-AMBR), and the like.

A filter (or referred to as an SDF template) contains parameters for characterizing data packets, and is configured to filter out a specific data packet to be bound to a specific QoS flow (i.e., a mapping of the data packet to the QoS flow in FIG. 2). The most commonly used filter is an IP five-tuple, i.e., a source and destination IP addresses, source and destination port numbers, and a protocol type.

The network-side user plane network element (the UPF in FIG. 2) and the terminal device (the UE in FIG. 2) form filters (such as the leftmost trapezoid and the rightmost parallelogram) based on combinations of data packet characteristic parameters to filter uplink or downlink data packets that conform to the data packet characteristics and are delivered on the user plane and bound to a specific data flow.

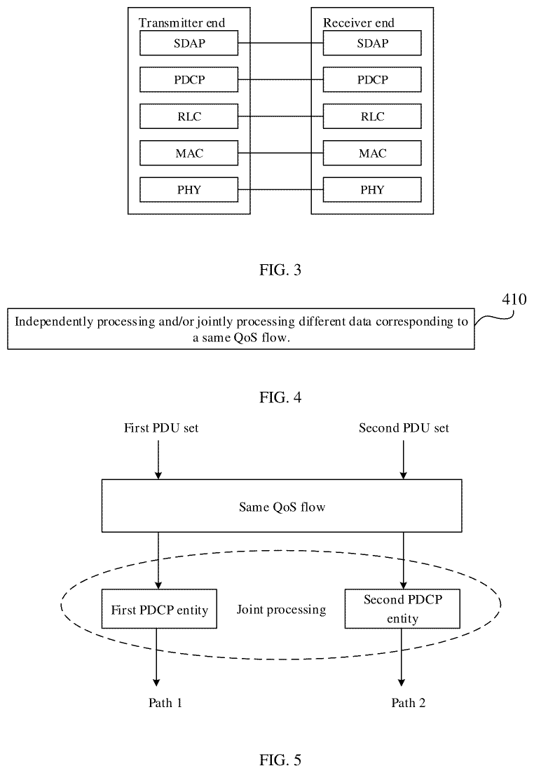

Referring to FIG. 3, a schematic diagram of a radio protocol architecture in the related art is shown.

A Service Data Adaptation Protocol (SDAP) is responsible for mapping QoS bearers to data radio bearers (DRBs) based on QoS requirements.

A Packet Data Convergence Protocol (PDCP) achieves IP header compression, encryption, and integrity protection. In handover, the PDCP further performs retransmission, in-order delivery, and deduplication. For dual connectivity with bearers separated, the PDCP may provide routing and replication, i.e., configuring a PDCP entity for each radio bearer of the terminal device.

Radio-link control (RLC) is responsible for data segmentation and retransmission. RLC provides services to PDCP in the form of RLC channels (or referred to as logical channels). Each of the RLC channels (corresponding to each radio bearer) configures one RLC entity for one terminal device.

Medium access control (MAC) is responsible for multiplexing of logical channels, HA ARQ retransmission, scheduling, and scheduling-related functions. The scheduling functions for uplink and downlink reside in gNBs. The MAC provides services to the RLC in the form of logical channels (LCHs). New radio (NR) changes a header structure of the MAC layer.

A physical layer (PHY) is responsible for encoding and decoding, modulation, demodulation, multi-antenna mapping, and other typical physical layer functions. A physical layer provides services to the MAC layer in the form of transport channels.

FIG. 4 illustrates a flowchart of a method for processing data according to some embodiments of the present disclosure. The method may include the following processes.

In process 410, different data corresponding to the same QoS flow is processed independently and/or jointly.

In some embodiments, independently processing different data corresponding to the same QoS flow means differentiating the processing of different data corresponding to the same QoS flow, or processing each different data corresponding to the same QoS flow independently. Different data is processed independly, which does not affect each other. For example, different data corresponding to the same QoS flow includes data 1 and data 2. Data 1 and data 2 are two pieces or two sets of different data corresponding to the same QoS flow. Independently processing data 1 and data 2 means independent processing of data 1 and independent processing of data 2. The processing of data 1 and the processing of data 2 are differentiated or independent and do not affect each other.

In some embodiments, jointly processing different data corresponding to the same QoS flow means collectively processing, co-processing, or non-independently processing different data corresponding to the same QoS flow. In this case, the joint processing of different data is considered comprehensively, with mutual influence existing among different data. For example, different data corresponding to the same QoS flow includes data 1 and data 2. Data 1 and data 2 are two pieces or two sets of different data corresponding to the same QoS flow. Jointly processing of data 1 and data 2 means jointly processing data 1 and data 2, considering the processing of data 1 and data 2 comprehensively, with mutual influence among them.

In some embodiments, different data corresponding to the same QoS flow is processed independently and jointly. Since there may be a plurality of types of processing for the data, some of the processing may be independently processing for different data corresponding to the same QoS flow, while other processing may be jointly processing for different data corresponding to the same QoS flow. For example, there may be processing A and processing B for the data. The different data corresponding to the same QoS flow includes data 1 and data 2, with data 1 and data 2 being two pieces or two sets of different data corresponding to the same QoS flow. For processing A, data 1 and data 2 may be processed independently. For processing B, data 1 and data 2 may be processed jointly.

In some embodiments, different data corresponds to different PDU sets. Different PDU sets corresponding to the same QoS flow are processed independently and/or jointly. For example, a first PDU set and a second PDU set corresponding to the same QoS flow are processed independently and/or jointly, wherein the first PDU set and the second PDU set are two different PDU sets.

In some embodiments, different data corresponds to PDU sets with different attributes. In some embodiments, the attributes include at least one of a type, an importance, an association, a priority, or a dependency.

In some embodiments, different data have different attributes. In some embodiments, the attributes include at least one of a type, an importance, an association, a priority, or a dependency.

In some embodiments, the type of the data and/or PDU sets is used to differentiate different types of data and/or PDU sets, such as the type of frame or the type of encoded slice. For example, whether it is an I-frame or a P-frame, or whether it is an I-encoded slice or a P-encoded slice.

In some embodiments, the importance of the data and/or PDU sets is an indicator to measure the importance degree of the data and/or PDU sets. Exemplarily, the importance may be divided into two different levels, such as important and unimportant; or the importance may be divided into three or more different levels. For instance, importance may be characterized by importance level values, with different importance level values corresponding to different degrees of importance. For example, importance level values may include two levels, 1 and 2, or three levels, 1, 2, and 3, or four levels, 1, 2, 3, and 4, or the like. The present disclosure does not limit the number of levels.

In some embodiments, the association of the data and/or PDU sets is an indicator to measure the degree of association between data and/or PDU sets. For example, the association may be divided into two different levels, such as associated and unassociated; or the association may be divided into three or more different levels. For instance, the association may be characterized by association level values, with different association level values corresponding to different degrees of association. For example, association level values may include two levels, 1 and 2, or three levels, 1, 2, and 3, or four levels, 1, 2, 3, and 4, or the like. The present disclosure does not limit the number of levels.

In some embodiments, the priority of the data and/or PDU sets is an indicator to measure the priority degree of the data and/or PDU sets. Exemplarily, the priority may be divided into two different levels, such as priority and non-priority; or the priority may be divided into three or more different levels. For instance, the priority may be characterized by priority level values, with different priority level values corresponding to different degrees of priority. For example, priority level values may include two levels, 1 and 2, or three levels, 1, 2, and 3, or four levels, 1, 2, 3, and 4, or the like. The present disclosure does not limit the number of levels.

In some embodiments, the dependency of the data and/or PDU sets is an indicator to measure the degree of dependency between data and/or PDU sets. For example, the dependency may be divided into two different levels, such as dependent and independent; or the dependency may be divided into three or more different levels. For instance, the dependency may be characterized by dependency level values, with different dependency level values corresponding to different degrees of dependency. For example, dependency level values may include two levels, 1 and 2, or three levels, 1, 2, and 3, or four levels, 1, 2, 3, and 4, or the like. The present disclosure does not limit the number of levels.

In some embodiments, different data corresponds to different paths. Paths are used for data transmission, such as for transmitting and/or receiving data. In some embodiments, the path is a radio bearer (RB). In some embodiments, the RB is a data radio bearer (DRB). For example, different data corresponds to different DRBs. For example, one QoS flow is mapped to different paths, such as different DRBs. For example, different data corresponding to the same QoS flow is mapped to different paths, such as different DRBs. Mapping data to a path means transmitting the data (including transmitting and/or receiving) over the path.

In some embodiments, different data corresponds to different paths, and different paths also refer to at least one of different RLCs, different logical channels, or different PDCPs.

In some embodiments, the method is applicable to a transmitter end, which independently processes and/or jointly processes different data corresponding to the same QoS flow.

In some embodiments, the transmitter end independently processes different data corresponding to the same QoS flow. The independent processing includes at least one of routing different data to different paths, identifying different data, or using different first functions for different data.

In some embodiments, the transmitter end is an SDAP layer. The SDAP layer routing different data to different paths includes: routing different data to different PDCP entities; or routing different data to different DRBs.

In some embodiments, the transmitter end is a PDCP layer. The PDCP layer routing different data to different paths includes: routing different data to different RLC entities; or routing different data to different logical channels.

In some embodiments, the transmitter end identifies different data, which includes at least one of the following cases 1 to 3.

Case 1: Different data is identified based on the PDU sets corresponding to the data.

For example, in the case where different data refers to different PDU sets, different data may be identified based on the PDU set to which the PDU belongs.

Case 2: Different data is identified based on the start identifier and/or end identifier of the PDU set.

For example, in the case where different data refers to different PDU sets, different data may be identified based on the start identifier and/or end identifier of the PDU set. The start identifier of the PDU set indicates the start position of the PDU set, such as indicating the PDU at the start position of the PDU set or the first PDU or indicating a start interval point of the PDU set. The end identifier of the PDU set indicates the end position of the PDU set, such as indicating the PDU at the end position of the PDU set or the last PDU or indicating an end interval point of the PDU set. Alternatively, different data is identified based on the interval identifiers between PDU sets, or different PDU sets are differentiated.

Case 3: Different data is identified based on the attributes of the data, and the attributes include at least one of a type, an importance, an association, a priority, or a dependency.

For example, in the case where different data have different attributes, the different data may be identified based on the attributes of the data. For example, in the case where different PDU sets have different attributes, the different PDU sets may be identified based on the attributes of the PDU sets. For the description of the attributes, reference may be made to the above embodiments, which is not be described here any further.

In addition, in the embodiments of the present disclosure, data is mainly exemplified as PDU sets. In some other embodiments, data are encoded slices, video frames, GOPs, or the like. For example, independent processing and/or joint processing is performed on different encoded slices corresponding to the same QoS flow; or independent processing and/or joint processing is performed on different frames (such as I-frames, P-frames, B-frames) corresponding to the same QoS flow; or independent processing and/or joint processing is performed on different GOPs corresponding to the same QoS flow.

In some embodiments, the transmitter end performs joint processing on different data corresponding to the same QoS flow. The joint processing includes at least one of: numbering the different data using a unified sequence number (SN), and using a unified first function for the different data. Furthermore, the same buffer is used for different data.

The transmitter end uses a unified SN for numbering different data, meaning that different data is jointly numbered. For example, data 1 and data 2 are different data, where data 1 includes data packets A, B, and C, and data 2 includes data packets D and E. In the case of joint numbering, exemplarily, the SN corresponding to data packet A is 1, the SN corresponding to data packet D is 2, the SN corresponding to data packet B is 3, the SN corresponding to data packet C is 4, and the SN corresponding to data packet E is 5. In the case of using independent numbering, exemplarily, the SN corresponding to data packet A is 1, the SN corresponding to data packet B is 2, the SN corresponding to data packet C is 3, the SN corresponding to data packet D is 1, and the SN corresponding to data packet E is 2. From the above example, the difference between independent numbering and joint numbering may be seen.

In some embodiments, the transmitter end uses a unified SN for numbering different PDU sets, meaning that different PDU sets are jointly numbered. For example, PDU set 1 and PDU set 2 are different PDU sets, wherein PDU set 1 includes PDUs A, B, and C, and PDU set 2 includes PDUs D and E. In the case of joint numbering, exemplarily, the SN corresponding to PDU A is 1, the SN corresponding to PDU B is 2, the SN corresponding to PDU D is 3, the SN corresponding to PDU C is 4, and the SN corresponding to PDU E is 5.

In some embodiments, the transmitter end uses a unified first function for different data, wherein the first function includes at least one of an integrity protection function, an encryption function, or a header compression function. Exemplarily, a unified first function is used for different PDU sets, wherein the first function includes at least one of an integrity protection function, an encryption function, or a header compression function.

In some embodiments, the above method is applicable to a receiver end, which independently processes and/or jointly processes different data corresponding to the same QoS flow.

In some embodiments, the receiver end independently processes different data corresponding to the same QoS flow, and independent processing includes at least one of: receiving different data from different paths, or using different second functions for different data.

In some embodiments, the receiver end is an SDAP layer. The SDAP layer receiving different data from different paths includes: receiving different data from different PDCP entities; or receiving different data from different DRBs.

In some embodiments, the receiver end is a PDCP layer. The PDCP layer receiving different data from different paths includes: receiving different data from different RLC entities; or receiving different data from different logical channels.

In some embodiments, the receiver end uses different second functions for different data, where the second functions include at least one of: an integrity authentication function, a decryption function, or a decompression function. Exemplarily, the receiver end uses different second functions for different PDU sets, where the second functions include at least one of: an integrity authentication function, a decryption function, or a decompression function.

In some embodiments, the receiver end performs joint processing on different data corresponding to the same QoS flow. Joint processing includes at least one of: reordering different data based on a unified SN; or using a unified second function for different data.

The receiver end reorders different data based on a unified SN, meaning that different data is jointly reordered. For example, data 1 and data 2 are different data, where data 1 includes data packets A, B, and C, and data 2 includes data packets D and E. In the case of joint reordering, exemplarily, the SN corresponding to data packet A received by the receiver end is 1, the SN corresponding to data packet B is 3, the SN corresponding to data packet C is 4, the SN corresponding to data packet D is 2, and the SN corresponding to data packet E is 5. The result of reordering the above data packets in ascending order of SN is as follows: data packet A, data packet D, data packet B, data packet C, and data packet E.

In some embodiments, the receiver end reorders different PDU sets based on a unified SN, meaning that different PDU sets are jointly reordered. For example, PDU set 1 and PDU set 2 are different PDU sets, where PDU set 1 includes PDUs A, B, and C, and PDU set 2 includes PDUs D and E. In the case of joint reordering, exemplarily, the SN corresponding to PDU A received by the receiver end is 1, the SN corresponding to PDU B is 2, the SN corresponding to PDU C is 4, the SN corresponding to PDU D is 3, and the SN corresponding to PDU E is 5. The result of reordering the above PDUs in ascending order of SN is as follows: PDU A, PDU B, PDU D, PDU C, and PDU E.

Furthermore, in some embodiments, in the case where the receiver end reorders different PDU sets based on a unified SN, data packets are delivered to the higher layer.

In some embodiments, the receiver end uses a unified second function for different data, where the second function includes at least one of: an integrity authentication function, a decryption function, or a decompression function. Exemplarily, the receiver end uses a unified second function for different PDU sets, where the second function includes at least one of: an integrity authentication function, a decryption function, or a decompression function.

In some embodiments, the joint processing performed by the transmitter end and/or the receiver end includes at least one of: the joint processing for the different data is a joint processing performed between protocol layers or entities; and the joint processing between protocol layers or entities is performed for data of the different data routed to different paths. In some embodiments, the protocol layer or entity is a PDCP protocol layer or PDCP entity; or the protocol layer or entity is a joint protocol layer or joint entity corresponding to the PDCP protocol layer or PDCP entity.

Taking the PDCP protocol layer as an example, joint processing performed between PDCP protocol layers or PDCP entities means that the PDCP protocol layer may include a plurality of different PDCP entities, and joint processing is performed between the plurality of different PDCP entities. Exemplarily, as shown in FIG. 5, the same QoS flow corresponds to two different PDU sets, including a first PDU set and a second PDU set, and the two different PDU sets correspond to two different paths. The PDCP protocol layer includes a first PDCP entity and a second PDCP entity, and the two PDCP entities perform joint processing on the above two different PDU sets.

In some embodiments, the joint processing is targeted at a plurality of different PDCP entities, and different data corresponds to the above different PDCP entities.

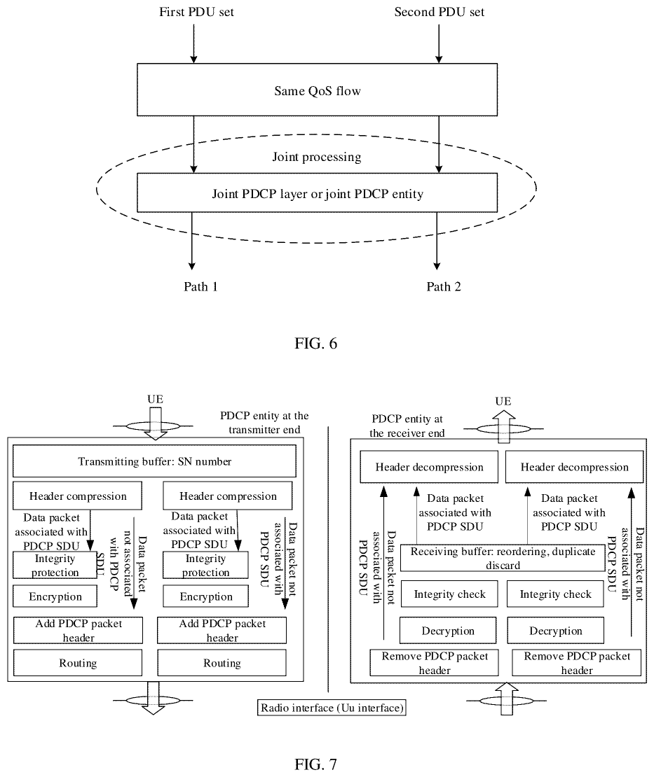

In some embodiments, the joint PDCP layer or joint PDCP entity corresponds to a plurality of different PDCP entities, and the above different data corresponds to different PDCP entities. Exemplarily, as shown in FIG. 6, the same QoS flow corresponds to two different PDU sets, including a first PDU set and a second PDU set, and the two different PDU sets correspond to two different paths. In some embodiments, different paths correspond to different PDCP entities. The joint PDCP layer or joint PDCP entity performs joint processing on the above two different PDU sets.

In some embodiments, different PDCP entities have a binding relationship or a joint processing relationship. For a plurality of different PDCP entities with a binding relationship or a joint processing relationship, joint processing is performed. In some embodiments, the binding relationship or the joint processing relationship, and/or the joint processing PDCP entity or the joint processing entity is configured by the network. For example, the configuration is done by the network over RRC.

In some embodiments, independent processing and/or joint processing of different data is performed in the same PDCP entity. In some embodiments, the PDCP entity reuses the dual active protocol stack (DAPS) architecture.

In the technical solutions according to the embodiments of the present disclosure, different data (such as different PDU sets) corresponding to the same QoS flow are processed independently and/or jointly. In the case of independently processing the different data corresponding to the same QoS flow, the processing of the different data corresponding to the same QoS flow may be considered separately and independently, offering greater flexibility and satisfying the different requirements of the different data. In the case of jointly processing the different data corresponding to the same QoS flow, the processing of the different data corresponding to the same QoS flow may be considered jointly, such that the mutual influence or association between the different data is considered, and the accuracy and rationality of processing the different data corresponding to the same QoS flow are enhanced.

Moreover, corresponding results are acquired by measuring and statistical analyzing the PDU set, such that measurement and statistical analysis at the granularity of the PDU set are achieved, which may be used for QoS monitoring and/or QoS verification at the granularity of the PDU set.

In some embodiments, the technical solutions of the present disclosure are applicable to UL (uplink) transmission scenarios, as well as DL (downlink) transmission scenarios. The transceiver parties are a terminal device and an access network device. For example, in a UL transmission scenario, the transmitter end is a terminal device, and the receiver end is an access network device; in a DL transmission scenario, the transmitter end is an access network device, and the receiver end is a terminal device.

In some embodiments, for the transmitter end (a terminal device in the UL scenario, or an access network device in the DL scenario), the transmitter end independently processes different data corresponding to the same QoS flow, which includes at least one of the following cases 1 to 3.

Case 1: Different data is identified.

In some embodiments, each or different PDU sets are identified, associated PDUs are identified, different types of PDU sets are identified, the association relationship or dependency relationship between PDU sets is identified, the importance of different PDU sets is identified, or the priority of different PDU sets is identified.

The association means that a PDU set functions individually but works together with other PDU sets to achieve an overall effect. The dependency means that a PDU set relies on one or more PDU sets to decode, use, or function, and both work together to achieve an overall effect. The importance refers to the degree of importance of a PDU set. The priority refers to the order of transmission or processing requirements of a PDU set, or the distinction of priority levels in transmission or processing requirements. The association relationship means that different PDU sets function individually but work together to achieve an overall effect. The dependency relationship means that a PDU set relies on one or more other PDU sets to decode, use, or function, and both work together to achieve an overall effect.

In some embodiments, different data is identified at the SDAP layer at the transmitter end.

In some embodiments, different data is identified at the PDCP layer at the transmitter end. For example, the SDAP layer at the transmitter end gives an indication to PDCP, or PDCP identifies the data by itself.

Case 2: Different data is routed to different paths.

In some embodiments, the corresponding relationship (or mapping relationship) between different data and different paths is configured by the access network device. For example, in the case where the transmitter end is a terminal device, the access network device may transmit signaling to the terminal device to configure the corresponding relationship between different data and different paths over the signaling. In some embodiments, the above signaling is RRC signaling or other signaling, which is not limited in the present disclosure. For example, in the case where the transmitter end is the access network device, the access network device may determine or configure the corresponding relationship between different data and different paths by itself.

In some embodiments, the SDAP layer and/or the PDCP layer at the transmitter end route different data to different paths.

In some embodiments, the SDAP layer and/or the PDCP layer at the transmitter end identifies the relationship between different data and different paths.

For the SDAP layer, the SDAP layer routes different data corresponding to the same QoS flow to different DRBs or PDCP entities, for example, identifying different data or different PDU sets based on SDAP.

For the PDCP layer, the PDCP layer routes different data corresponding to the same QoS flow to different RLC entities or logical channels. For example, the PDCP layer routes data of different DRBs of one PDCP entity to different RLC entities, or routes different data to different RLC entities.

Case 3: Different first functions are used for different data, wherein the first functions include at least one of an integrity protection function, an encryption function, or a header compression function.

For example, different integrity protection functions and/or different encryption functions are used for different data of a plurality of DRBs or RLC entities of one PDCP entity.

For example, different integrity protection functions, and/or different encryption functions, and/or different header compression functions are used for different data of a plurality of DRBs or RLC entities of one PDCP entity.

In some embodiments, for the transmitter end (a terminal device in the UL scenario, or an access network device in the DL scenario), the transmitter end jointly processes different data corresponding to the same QoS flow, which includes at least one of the following cases 1 to 2.

Case 1: A unified SN is used for numbering different data.

For example, a unified SN is used for numbering different data of a plurality of DRBs or RLC entities of one PDCP entity.

For example, a unified SN is used for numbering different data of a plurality of associated PDCP or DRB entities.

Case 2: A unified first function is used for different data, wherein the first function includes at least one of an integrity protection function, an encryption function, or a header compression function.

For example, a unified header compression function is used for different data of a plurality of DRBs or RLC entities of one PDCP entity.

For example, a unified header compression function is used for different data of a plurality of associated PDCP or DRB entities.

In some embodiments, one PDCP entity includes one DRB, and one PDCP corresponds to one or more RLC entities. Different DRBs or RLC entities transmit different data. For example, the PDCP entity may be one or each of a plurality of associated PDCPs.

In some embodiments, one PDCP entity corresponds to one DRB, different DRBs correspond to different integrity protection functions and/or different encryption functions. Furthermore, different DRBs may also correspond to different header compression functions or a unified header compression function. For example, the PDCP entity may be one or each of a plurality of associated PDCPs.

In some embodiments, one PDCP entity includes more than one DRB, and each DRB corresponds to one RLC entity. Different DRBs or RLC entities transmit different data. The PDCP at the transmitter end implements the above independent and/or joint processing of different data corresponding to the same QoS flow. For example, two or more DRBs are provided, and two or more RLC entities are provided.

In some embodiments, in more than one DRB corresponding to one PDCP entity, or in a plurality of corresponding RLC entities, different DRBs or RLC entities correspond to different integrity protection functions and/or different encryption functions. Furthermore, different DRBs or RLC entities may also correspond to different header compression functions or a unified header compression function. The functions are implemented in the PDCP.

In some embodiments, the DAPS PDCP layer function architecture of the transmitter end is reused. The functions are implemented in the PDCP.

In some embodiments, for the receiver end (an access network device in the UL scenario, or a terminal device in the DL scenario), the receiver end independently processes different data corresponding to the same QoS flow, which includes at least one of the following cases 1 to 2.

Case 1: Different data from different paths are received.

In some embodiments, the corresponding relationship (or mapping relationship) between different data and different paths is configured by the access network device. For example, in the case where the receiver end is a terminal device, the access network device may transmit signaling to the terminal device to configure the corresponding relationship between different data and different paths over the signaling. In some embodiments, the above signaling is RRC signaling or other signaling, which is not limited in the present disclosure. For example, in the case where the receiver end is the access network device, the access network device may determine or configure the corresponding relationship between different data and different paths by itself.

In some embodiments, the SDAP layer and/or the PDCP layer at the receiver end receive different data from different paths.

For the SDAP layer, the SDAP layer receives different data from different PDCP entities; or receives different data from different DRBs.

For the PDCP layer, the PDCP layer receives different data from different RLC entities; or receives different data from different logical channels.

Case 2: Different second functions are used for different data, wherein the second functions include at least one of an integrity authentication function, a decryption function, or a decompression function.

For example, different integrity authentication functions and/or different decryption functions are used for different data of a plurality of DRBs or RLC entities of one PDCP entity.

For example, different integrity authentication functions and/or different decryption functions are used for one or each PDCP entity of a plurality of associated PDCPs, or for one or each DRB of a plurality of associated PDCPs.

For example, different integrity authentication functions, and/or different decryption functions, and/or different decompression functions are used for one or each PDCP entity of a plurality of associated PDCPs, or for one or each DRB of a plurality of associated PDCPs.

In some embodiments, for the receiver end (an access network device in the UL scenario, or a terminal device in the DL scenario), the receiver end jointly processes different data corresponding to the same QoS flow, which includes at least one of the following cases 1 to 2.

Case 1: Different data is reordered based on a unified SN.

For example, different data of a plurality of DRBs or RLC entities of one PDCP entity is reordered based on a unified SN. The purpose is to ensure that different data (such as different PDU sets) are delivered to the higher layer in order. In some embodiments, a unified SN corresponding to different data of a plurality of DRBs or RLC entities of one PDCP entity is used to perform reordering. The reordering is implemented in the PDCP.

For example, a plurality of associated PDCPs are reordered based on a unified SN. The purpose is to ensure that different data (such as different PDU sets) is delivered to the higher layer in order. In some embodiments, a unified SN corresponding to different data of the joint PDCP entities is used to perform reordering. The reordering is implemented in the joint PDCP or the joint protocol layer.

Case 2: A unified second function is used for different data, wherein the second function includes at least one of an integrity authentication function, a decryption function, or a decompression function.

For example, a unified decompression function is used for different data of a plurality of DRBs or RLC entities of one PDCP entity.

In some embodiments, one PDCP entity includes more than one DRB, and each DRB corresponds to one RLC entity. Different data from different RLC entities is received. The PDCP at the receiver end implements the above independent and/or joint processing of different data corresponding to the same QoS flow. For example, two or more DRBs are provided. Two or more RLC entities are provided.

For example, a unified decompression function is used for different data of a plurality of associated PDCP or DRB entities.

In some embodiments, one PDCP entity includes one DRB, and one PDCP corresponds to one or more RLC entities. Different DRBs or RLC entities transmit different data. For example, the PDCP entity may be one or each of a plurality of associated PDCPs.

In some embodiments, one DRB corresponds to one PDCP entity, different DRBs correspond to different integrity authentication functions and/or different decryption functions. Furthermore, different DRBs may also correspond to different decompression functions or a unified decompression function. For example, the PDCP entity may be one or each of a plurality of associated PDCPs.

In some embodiments, in more than one DRB corresponding to one PDCP entity, or in a plurality of corresponding RLC entities, different DRBs or RLC entities correspond to different integrity authentication functions and/or different decryption functions. Furthermore, different DRBs or RLC entities may also correspond to different decompression functions or a unified decompression function. The functions are implemented in the PDCP.

In some embodiments, the DAPS PDCP layer function architecture of the receiver end is reused. The functions are implemented in the PDCP.

In some embodiments, for the transmitter end, at least one of the following processes S0 to S2 is performed (in some embodiments, the order of the processes is not restricted).

In S0, the RRC configures the mapping relationship between one QoS flow and a plurality of paths, wherein one QoS flow corresponds to a plurality of DRBs, one PDCP entity corresponds to a plurality of RBs, and one PDCP corresponds to a plurality of RLCs.

In some embodiments, different DRBs or PDCPs are correspondingly configured with different indications (such as I/P-frames), or different DRBs or PDCPs are correspondingly configured with different flags (e.g., reliable or unreliable, important or non-important, different importance levels, different reliability levels, or different priorities).

In some embodiments, different RLCs are correspondingly configured with different indications (such as I/P-frames), or different RLCs are correspondingly configured with different flags (e.g., reliable or unreliable, important or non-important, different importance levels, different reliability levels, or different priorities).

In S1, the action of the SDAP at the transmitter end includes at least one of the following actions 1 to 2.

Action 1: The SDAP identifies different data.

For example, to identify different PDU sets, the SDAP knows the type of a PDU set based on higher layer information, identifies different data based on the data packet header of the higher layer (such as the GTP-U message from the core network), or identifies which data goes to which path based on the indication in the DL SDAP packet header.

Action 2: The SDAP routes different data, and/or indicates different information of different data to the lower layer (PDCP).

For example, for an SDAP SDU of a QoS flow received from the higher layer, the SDAP entity at the transmitter end performs at least one of the following actions: generating an SDAP PDU; distributing the PDU to the corresponding or correct lower layer path based on the mapping relationship configured by the RRC; and indicating different information of different data to the lower layer (PDCP). For example, the different information may be: importance, an association, a priority, a dependency, a frame type, or a packet type.

In S2, the action of the PDCP at the transmitter end includes at least one of the following actions 1 to 5.

Action 1: In the case of submitting one PDCP PDU to the lower layer, the PDCP entity at the transmitter end acts as follows: in the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLC entities associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLC entities and transmits different PDU sets (corresponding to one QoS flow), then different PDCP PDUs are submitted to different RLC entities. Specifically, the first PDCP PDU is submitted to the first RLC entity, and the second PDCP PDU is submitted to the second RLC entity. Whether the PDCP PDU is the first or the second PDCP PDU is determined by the PDCP entity at the transmitter end based on the indication from the SDAP or the routing result of the SDAP. The mapping relationship between the first and second RLC entities and the first and second PDCP PDUs is configured by the RRC. The PDCP PDU includes PDCP data PDUs and/or PDCP control PDUs.

Furthermore, the action 1 is not performed or not satisfied in the case of split transmission, or the action 1 is performed in the case of not performing split transmission.

Action 2: In the case where the PDCP entity at the transmitter end is associated with at least two RLC entities, or the joint PDCP entity is associated with different RLC entities and transmits different PDU sets (corresponding to one QoS flow), and in the case of indicating that the size/volume of the PDCP data of the MAC entity is used for BSR triggering (buffer status report triggering) and buffer size calculation, the PDCP entity at the transmitter end acts as follows: in the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, etc.); or in the case where the PDCP entity at the transmitter end is associated with at least two RLC entities, and different RLC entities associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLC entities and transmits different PDU sets (corresponding to one QoS flow), then the size/volume of the PDCP data is indicated to the MAC entity associated with the first RLC, wherein the first RLC is pre-configured, or indicated by the network, or either one, or default.

Furthermore, the above action 2 is not performed or not satisfied in the case of split transmission, or the above action 2 is performed in the case of not performing split transmission.

Action 3: Header compression processing:

In the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then unified header compression processing is performed.

Alternatively, in the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then based on the RLC entity over which the PDCP SDU is transmitted, the PDCP entity uses header compression protocols respectively corresponding to the different RLCs or RBs (configured for different RLCs or RBs) to perform header compression processing.

Action 4: Encryption processing:

In the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then unified encryption processing is performed.

Alternatively, in the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then based on the RLC entity over which the PDCP SDU is transmitted, the PDCP entity uses encryption algorithms and/or keys respectively corresponding to the different RLCs or RBs (configured for different RLCs or RBs) to perform encryption processing.

Action 5: Integrity protection processing:

In the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then unified integrity protection processing is performed.

Alternatively, in the case where the PDCP entity at the transmitter end is associated with at least two RLC entities, and the PDCP entity at the transmitter end is associated with the first RB (the first RB being an RB with a special identifier, or an RB with an XR identifier, or an RB with a differentiated processing identifier, or the like); or in the case where the PDCP entity at the transmitter end is associated with at least two RLC entities, and different RLCs associated with the PDCP entity at the transmitter end correspond to different RBs; or in the case where the PDCP entity at the transmitter end is associated with at least two RLC entities, and the PDCP entity at the transmitter end differentiates the processing of different PDU sets or data; or in the case where the joint PDCP entity is associated with different RLCs and transmits different PDU sets (corresponding to one QoS flow), then based on the RLC entity over which the PDCP SDU is transmitted, the PDCP entity uses integrity algorithms and/or keys respectively corresponding to the different RLCs or RBs (configured for different RLCs or RBs) to perform integrity protection processing.

In some embodiments, for the receiver end, at least one of the following processes S0 to S2 is performed (in some embodiments, the order of the processes is not restricted).

In S0 (optional process), in the case where the receiver end is an access network device, the access network device configures a mapping relationship between one Qos flow and a plurality of paths, where one QoS flow corresponds to a plurality of DRBs, one PDCP entity corresponds to a plurality of RBs, and one PDCP corresponds to a plurality of RLCs. The access network device indicates the above configuration information to the terminal device over an RRC message.

In some embodiments, different DRBs or PDCPs are correspondingly configured with different indications (such as I/P-frames), or different DRBs or PDCPs are correspondingly configured with different flags (e.g., reliable or un reliable, important or non-important, different importance levels, different reliability levels, or different priorities).

In some embodiments, different RLCs are correspondingly configured with different indications (such as I/P-frames), or different RLCs are correspondingly configured with different flags (e.g., reliable or unreliable, important or non-important, different importance levels, different reliability levels, or different priorities).

In S1, the action of the PDCP at the receiver end includes at least one of the following actions 1 to 4.

Action 1: The PDCP entity at the receiver end, or the joint PDCP entity at the receiver end, performs unified buffering and/or reordering for different data based on a unified SN.

Action 2: Decompression processing:

In the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where the PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then unified decompression processing is performed.

Alternatively, in the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where the PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then based on the RLC entity over which the PDCP SDU is received, the PDCP entity uses header compression protocols respectively corresponding to the different RLCs or RBs (configured for different RLCs or RBs) to perform decompression processing.

Action 3: Decryption processing:

In the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where the PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then unified decryption processing is performed.

Alternatively, in the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where the PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then based on the RLC entity over which the PDCP SDU is received, the PDCP entity uses header compression protocols respectively corresponding to the different RLCs or RBs (configured for different RLCs or RBs) to perform decryption processing.

Action 4: Integrity verification (also referred to as integrity authentication or integrity check) processing:

In the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then unified integrity verification processing is performed.

Alternatively, in the case where the PDCP entity at the receiver end is associated with at least two RLC entities, and the PDCP entity at the receiver end is associated with the first RB (the first RB being an RB with a special identifier, or an RB with an XR identifier, or an RB with a differentiated processing identifier, or the like); or in the case where the PDCP entity at the receiver end is associated with at least two RLC entities, and different RLCs associated with the PDCP entity at the receiver end correspond to different RBs; or in the case where the PDCP entity at the receiver end is associated with at least two RLC entities, and the PDCP entity at the receiver end differentiates the processing of different PDU sets or data; or in the case where the joint PDCP entity is associated with different RLCs and transmits different PDU sets (corresponding to one QoS flow), then based on the RLC entity over which the PDCP SDU is received, the PDCP entity uses header compression protocols respectively corresponding to the different RLCs or RBs (configured for different RLCs or RBs) to perform integrity verification processing.

In S2, the SDAP receives different data corresponding to one QoS flow from the underlying layer. Specifically, the SDAP receives the data from different DRBs.

In some embodiments, as shown in FIGS. 7 to 10, several methods for data processing are exemplarily illustrated in the schematic diagrams.

In FIG. 7, for different data corresponding to the same QoS flow (such as different PDU sets), the PDCP entity at the transmitter end uses a unified buffer at the transmitter end for the different data and numbers the different data with a unified SN. The PDCP entity at the transmitter end applies independent header compression functions, independent integrity protection functions, and independent encryption functions to the different data and routes the different data to different paths, such as different RLC entities. For different data corresponding to the same QoS flow (such as different PDU sets), the PDCP entity at the receiver end applies independent decryption functions, independent integrity check functions, and independent header decompression functions to the different data, uses a unified receiving buffer, and reorders the different data based on the unified SN.

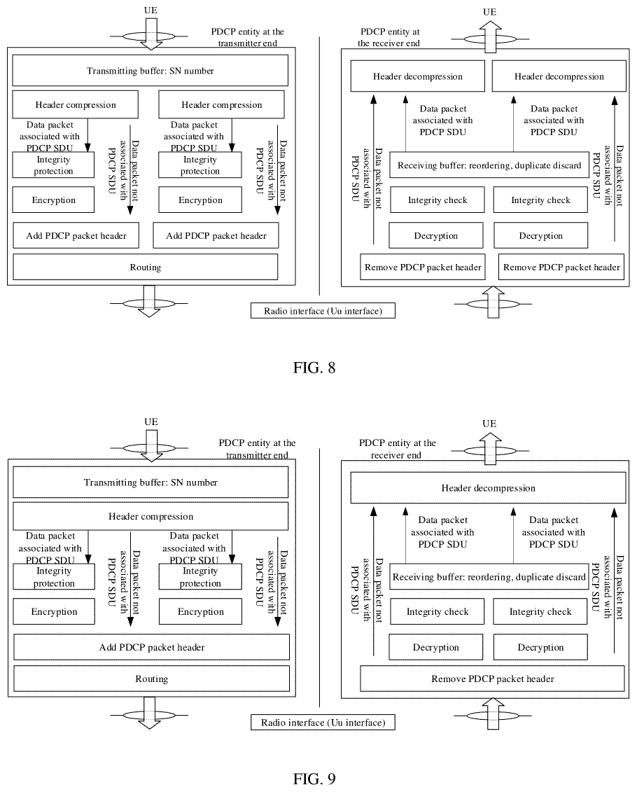

In FIG. 8, for different data corresponding to the same QoS flow (such as different PDU sets), the PDCP entity at the transmitter end uses a unified buffer at the transmitter end for the different data and numbers the different data with a unified SN. The PDCP entity at the transmitter end applies independent header compression functions, independent integrity protection functions, and independent encryption functions to the different data and routes the different data to the same path, such as the same RLC entity. For different data corresponding to the same QoS flow (such as different PDU sets), the PDCP entity at the receiver end applies independent decryption functions, independent integrity check functions, and independent header decompression functions to the different data, uses a unified receiving buffer, and reorders the different data based on the unified SN.

In FIG. 9, for different data corresponding to the same QoS flow (such as different PDU sets), the PDCP entity at the transmitter enduses a unified buffer at the transmitter end for the different data and numbers the different data with a unified SN. The PDCP entity at the transmitter end applies a unified header compression function, independent integrity protection functions, and independent encryption functions to the different data and routes the different data to the same path, such as the same RLC entity. For different data corresponding to the same QoS flow (such as different PDU sets), the PDCP entity at the receiver end applies independent decryption functions, independent integrity check functions, and a unified header decompression function to the different data, uses a unified receiving buffer, and reorders the different data based on the unified SN.

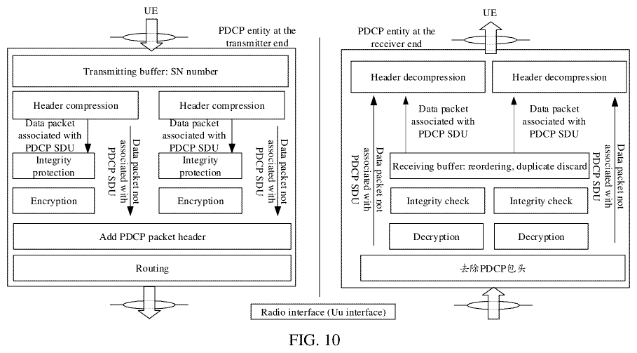

In FIG. 10, for different data corresponding to the same QoS flow (such as different PDU sets), the PDCP entity at the transmitter end uses a unified buffer at the transmitter end for the different data and numbers the different data with a unified SN. The PDCP entity at the transmitter end applies independent header compression functions, independent integrity protection functions, and independent encryption functions to the different data and routes the different data to the same path, such as the same RLC entity. For different data corresponding to the same QoS flow (such as different PDU sets), the PDCP entity at the receiver end applies independent decryption functions, independent integrity check functions, and independent header decompression functions to the different data, uses a unified receiving buffer, and reorders the different data based on the unified SN.

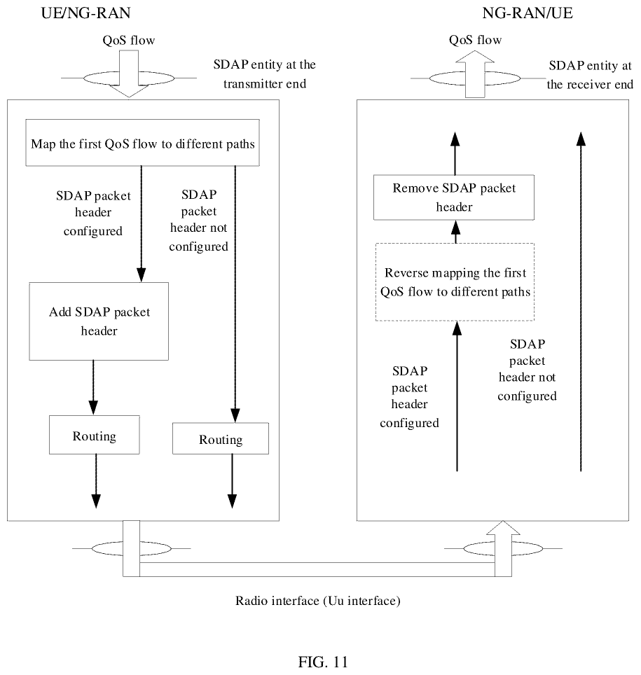

In some embodiments, as shown in FIGS. 11 to 12, several methods for data processing are exemplarily illustrated in the schematic diagrams.

In FIG. 11, for different data corresponding to the same QoS flow (such as different PDU sets), the SDAP entity at the transmitter end routes the different data to different paths (such as different DRBs or different PDCP entities), and the SDAP entity at the receiver end receives the different data from the different paths.

In FIG. 12, for different data corresponding to the same QoS flow (such as different PDU sets), the SDAP entity at the transmitter end identifies PDU sets to which the different data belong and routes the different data belonging to different PDU sets to different paths (such as different DRBs or different PDCP entities); and the SDAP entity at the receiver end receives the different data belonging to different PDU sets from the different paths.

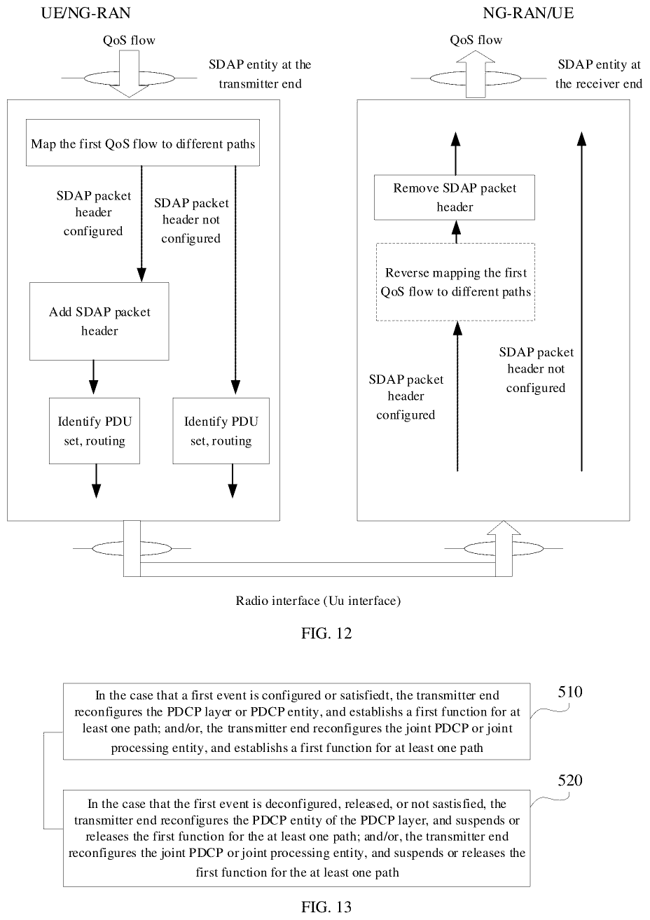

In some embodiments, as shown in FIG. 13, the present disclosure further provides a flowchart of a method for PDCP reconfiguration or a method for reconfiguring a joint PDCP or joint processing entity. The method includes at least one of the following processes 510 and 520.

In process 510, in the case that a first event is configured or satisfied, the transmitter end reconfigures the PDCP layer or PDCP entity, and establishs a first function for at least one path; and/or, the transmitter end reconfigures the joint PDCP or joint processing entity, and establishs a first function for at least one path.

In process 520, in the case that the first event is deconfigured, released, or not satisfied, the transmitter end reconfigures the PDCP entity of the PDCP layer, and suspends or releases the first function for at least one path; and/or, the transmitter end reconfigures the joint PDCP or joint processing entity, and suspends or releases the first function for at least one path.

In some embodiments, the transmitter end is a terminal device or an access network device. For example, for UL, the transmitter end is a terminal device; for DL, the transmitter end is an access network device.

In some embodiments, the first function includes at least one of: an encryption function, an integrity protection function, or a header compression function.

In some embodiments, the establishment of the first function for at least one path in process 510 includes at least one of the following actions 1 to 4.

Action 1: An encryption function is established for at least one path, and the encryption function is performed using the encryption algorithm and key provided by the upper layer.

Action 2: An integrity protection function is established for at least one path, and the integrity protection function is implemented using the integrity protection algorithm and key provided by the upper layer.

Action 3: A header compression function is established for at least one path, and the header compression function is configured using the header compression protocol provided by the upper layer.

Action 4: The at least one path or the PDCP/RLC (or the like) corresponding to the path is established.

In some embodiments, the suspension or release of the first function for at least one path in process 520 includes at least one of the following actions 1 to 4.

Action 1: An encryption function is suspended or released for at least one path, wherein the encryption function corresponds to the released RLC entity, the released path (such as RB), or the RB or RLC entity corresponding to the first event.

Action 2: An integrity protection function is suspended or released for at least one path, wherein the integrity protection function corresponds to the released RLC entity, the released path (such as RB), or the RB or RLC entity corresponding to the first event.

Action 3: A header compression function is suspended or released for at least one path, wherein the header compression function corresponds to the released RLC entity, the released path (such as RB), or the RB or RLC entity corresponding to the first event.

Action 4: The at least one path or the PDCP/RLC (or the like) corresponding to the path is suspended or released.

In some embodiments, a joint PDCP entity or a joint protocol entity is associated with a plurality of different PDCPs. Different PDCPs correspond to different RLCs or different RBs. For example, a joint PDCP or protocol layer is associated with a first PDCP and a second PDCP, wherein the first PDCP corresponds to a first RLC and the second PDCP is associated with a second RLC.

In some embodiments, the PDCP layer is associated with a plurality of different RLC entities, and the plurality of different RLC entities correspond to a plurality of different paths. For example, the PDCP layer is associated with a first RLC entity and a second RLC entity, and the first RLC entity is different from the second RLC entity. The first RLC entity corresponds to one or more paths, and the second RLC entity corresponds to one or more paths, with the one or more paths corresponding to the first RLC entity being different from the one or more paths corresponding to the second RLC entity.

In some embodiments, the PDCP layer is associated with a plurality of different RLC entities, with each RLC entity corresponding to one path. For example, the PDCP layer is associated with a first RLC entity and a second RLC entity, and the first RLC entity is different from the second RLC entity; the first RLC entity corresponds to a first path, and the second RLC entity corresponds to a second path, with the first path being different from the second path.

Exemplarily, the PDCP layer is associated with a plurality of different RLC entities, and the plurality of different RLC entities correspond to a plurality of different paths, or each RLC entity corresponds to one path, that is, the PDCP layer is associated with a plurality of different paths. The at least one path in process 510 and/or process 520 is: all of the plurality of different paths, or part of the plurality of different paths.

For example, the PDCP layer is associated with a first RLC entity and a second RLC entity, and the first RLC entity is different from the second RLC entity. The first RLC entity corresponds to a first path, and the second RLC entity corresponds to a second path, with the first path being different from the second path. In the case where a first function is established for one of the paths, or the first function is suspended or released for one of the paths, it indicates that one path has already been established, and currently, another path is being added or released, that is, a default or existing path is present in the PDCP entity. In the case where the first function is established for both the first path and the second path, or the first function is suspended or released for both the first path and the second path, it indicates that the first function is established or released together for all paths corresponding to the PDCP entity.

In some embodiments, the first event includes at least one of the following cases 1 to 7.

Case 1: One QoS flow corresponds to a plurality of paths, or a specific QoS flow corresponds to a plurality of paths.

Case 2: Different data corresponding to a QoS flow are configured for independent processing and/or joint processing.

Case 3: A plurality of paths are associated with one PDCP entity, and different paths correspond to different identifiers. The identifiers include at least one of: special identifiers (such as I-frames or P-frames, different importance, different priorities, different dependencies, or different associations), XR identifiers, or differentiated processing identifiers.

Case 4: A plurality of PDCP layers or entities are associated with a protocol layer or entity of joint processing.

Case 5: A PDCP layer or entity is associated with a plurality of different RLC entities, and the PDCP layer is associated with a target path. The target path includes at least one of: a path with a special identifier, a path with an XR identifier, or a path with a differentiated processing identifier.

Case 6: A PDCP layer or entity is associated with a plurality of different RLC entities, and the different RLC entities correspond to different paths.

Case 7: A PDCP layer or entity is associated with a plurality of different RLC entities, and the PDCP layer differentiates the processing of different data for the different RLC entities.

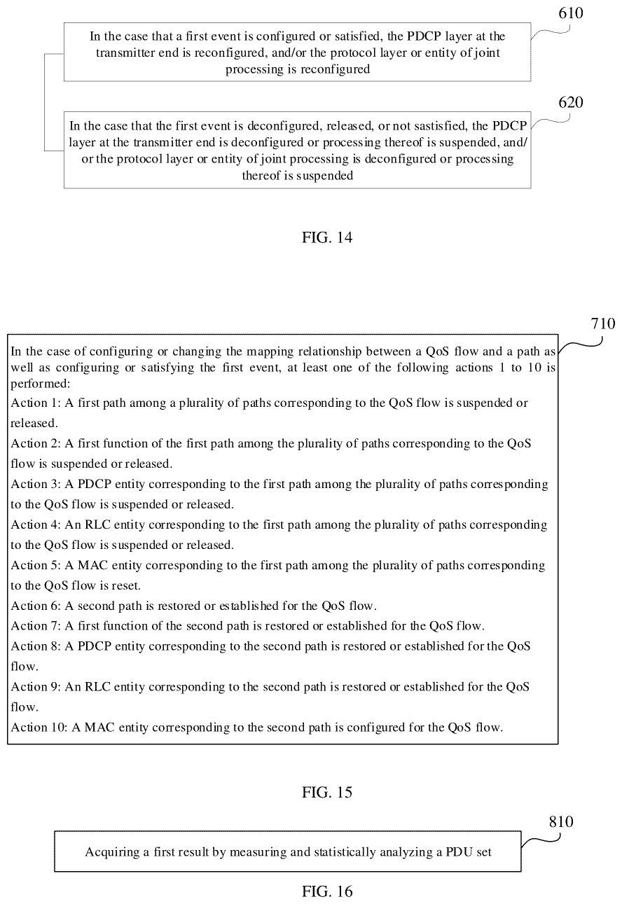

In some embodiments, as shown in FIG. 14, the present disclosure further provides a flowchart of a method for PDCP reconfiguration or a method for reconfiguring a joint PDCP or joint processing entity. The method includes at least one of the following processes 610 and 620.

In process 610, in the case that a first event is configured or satisfied, the PDCP layer at the transmitter end is reconfigured, and/or the protocol layer or entity of joint processing is reconfigured.

In process 620, in the case that the first event is deconfigured, released, or not satisfied, the PDCP layer at the transmitter end is deconfigured or the processing thereof is suspended, and/or the protocol layer or entity of joint processing is deconfigured or the processing thereof is suspended.

In some embodiments, the transmitter end is a terminal device or an access network device. For example, for UL, the transmitter end is a terminal device; for DL, the transmitter end is an access network device.

In some embodiments, the protocol layer or entity performing joint processing is used for performing the above joint processing on different data corresponding to the same QoS flow, optionally also used for performing the above independent processing on different data corresponding to the same QoS flow. In some embodiments, the protocol layer or entity performing joint processing is the PDCP layer or PDCP entity performing joint processing.

In some embodiments, the first event includes at least one of the following cases 1 to 7.

Case 1: One QoS flow corresponds to a plurality of paths, or a specific QoS flow corresponds to a plurality of paths.

Case 2: Different data corresponding to a QoS flow are configured for independent processing and/or joint processing.

Case 3: A plurality of paths are associated with one PDCP entity, and different paths correspond to different identifiers, wherein the identifiers include at least one of: special identifiers (such as I-frames or P-frames, different importance, different priorities, different dependencies, or different associations), XR identifiers, or differentiated processing identifiers.

Case 4: A plurality of PDCP layers or entities are associated with a protocol layer or entity of joint processing.

Case 5: A PDCP layer or entity is associated with a plurality of different RLC entities, and the PDCP layer is associated with a target path, wherein the target path includes at least one of: a path with a special identifier, a path with an XR identifier, or a path with a differentiated processing identifier.

Case 6: A PDCP layer or entity is associated with a plurality of different RLC entities, and the different RLC entities correspond to different paths.

Case 7: A PDCP layer or entity is associated with a plurality of different RLC entities, and the PDCP layer differentiates the processing of different data for the different RLC entities.

The technical solutions according to the embodiments shown in FIGS. 13 and 14 are applicable to cases where different data (such as different PDU sets, different encoded slices, and different frames) are mapped to the same QoS flow. The different data (such as different PDU sets) may be data with different importance, data with different associations, data with different dependencies, or data with different priorities. By the technical solutions of the embodiments, modifications to the PDCP function are achieved by PDCP reconfiguration, thereby supporting the above-mentioned independent processing and/or joint processing of different data by the PDCP.

In some embodiments, as shown in FIG. 15, the present disclosure further provides a flowchart for configuring or changing the mapping relationship between a QoS flow and a path. The method includes the following process 710.

In process 710, in the case that the mapping relationship between a QoS flow and a path is configured or changed and a first event is configured or satisfied, at least one of the following actions 1 to 10 is performed.

Action 1: A first path among a plurality of paths corresponding to the QoS flow is suspended or released.

Action 2: A first function of the first path among the plurality of paths corresponding to the QoS flow is suspended or released.

Action 3: A PDCP entity corresponding to the first path among the plurality of paths corresponding to the QoS flow is suspended or released.

Action 4: An RLC entity corresponding to the first path among the plurality of paths corresponding to the QoS flow is suspended or released.

Action 5: A MAC entity corresponding to the first path among the plurality of paths corresponding to the QoS flow is reset.

Action 6: A second path is restored or established for the QoS flow.

Action 7: A first function of the second path is restored or established for the QoS flow.

Action 8: A PDCP entity corresponding to the second path is restored or established for the QoS flow.

Action 9: An RLC entity corresponding to the second path is restored or established for the QoS flow.

Action 10: A MAC entity corresponding to the second path is configured for the QoS flow.

In some embodiments, the first path is a default path or a path determined based on the stored mapping relationship between the QoS flow and the path. Taking the example where the same QoS flow corresponds to a plurality of DRBs, the first path is a first DRB, and the first DRB is a default DRB or a DRB determined according to the stored QoS flow to DRB mapping rule.

In some embodiments, the second path is a changed path determined based on the configured, updated, or indicated mapping relationship between the QoS flow and the path. Taking the example where the same QoS flow corresponds to a plurality of DRBs, the second path is a second DRB, and the second DRB is a changed DRB corresponding to the configured, updated, or indicated QoS flow to DRB mapping rule.

In some embodiments, the first path includes all or part of the plurality of paths corresponding to the same QoS flow. Taking the example where the same QoS flow corresponds to a plurality of DRBs, the first DRB is one or more of the plurality of DRBs. In some embodiments, one DRB is an additional DRB or a DRB that requires modification of the mapping relationship. In some embodiments, the plurality of DRBs are all the DRBs corresponding to the PDCP entity.

In some embodiments, the second path includes all or part of the plurality of paths corresponding to the same QoS flow. Taking the example where the same QoS flow corresponds to a plurality of DRBs, the second DRB is one or more of the plurality of DRBs. In some embodiments, one DRB is an additional DRB or a DRB that requires modification of the mapping relationship. In some embodiments, the plurality of DRBs are all the DRBs corresponding to the PDCP entity.

In some embodiments, the first event includes at least one of the following cases 1 to 7.

Case 1: One QoS flow corresponds to a plurality of paths, or a specific QoS flow corresponds to a plurality of paths.

Case 2: Different data corresponding to a QoS flow are configured for independent processing and/or joint processing.

Case 3: A plurality of paths are associated with one PDCP entity, and different paths correspond to different identifiers, wherein the identifiers include at least one of: special identifiers (such as I-frames or P-frames, different importance, different priorities, different dependencies, or different associations), XR identifiers, or differentiated processing identifiers.

Case 4: A plurality of PDCP layers or entities are associated with a protocol layer or entity of joint processing.

Case 5: A PDCP layer or entity is associated with a plurality of different RLC entities, and the PDCP layer is associated with a target path, wherein the target path includes at least one of: a path with a special identifier, a path with an XR identifier, or a path with a differentiated processing identifier.

Case 6: A PDCP layer or entity is associated with a plurality of different RLC entities, and the different RLC entities correspond to different paths.

Case 7: A PDCP layer or entity is associated with a plurality of different RLC entities, and the PDCP layer differentiates the processing of different data for the different RLC entities.

In some embodiments, for action 2, the first function of the first path among the plurality of paths corresponding to the QoS flow is suspended or released, and the first function includes at least one of: an encryption function, an integrity protection function, or a header compression function. In some embodiments, suspending or releasing the first function of the first path among the plurality of paths corresponding to the QoS flow includes at least one of the following actions 2-1 to 2-4.

Action 2-1: An encryption function of the first path is suspended or released, wherein the encryption function corresponds to the released RLC entity, the released path (such as RB), or the RB or RLC entity corresponding to the first event.

Action 2-2: An integrity protection function of the first path is suspended or released, wherein the integrity protection function corresponds to the released RLC entity, the released path (such as RB), or the RB or RLC entity corresponding to the first event.

Action 2-3: A header compression function of the first path is suspended or released, wherein the header compression function corresponds to the released RLC entity, the released path (such as RB), or the RB or RLC entity corresponding to the first event.

Action 2-4: The first path or the PDCP/RLC (or the like) corresponding to the first path is suspended or released.

In some embodiments, for action 7, the first function of the second path is restored or established for the QoS flow, and the first function includes at least one of: an encryption function, an integrity protection function, or a header compression function. In some embodiments, restoring or establishing the first function of the second path for the QoS flow includes at least one of the following actions 7-1 to 7-4.

Action 7-1: An encryption function is established for the second path, and the encryption function is performed using the encryption algorithm and key provided by the upper layer.

Action 7-2: An integrity protection function is established for the second path, and the integrity protection function is implemented using the integrity protection algorithm and key provided by the upper layer.

Action 7-3: A header compression function is established for the second path, and the header compression function is configured using the header compression protocol provided by the upper layer.

Action 7-4: The second path or the PDCP/RLC (or the like) corresponding to the second path is established.

In some embodiments, for action 3, the PDCP entity corresponding to the first path among the plurality of paths corresponding to the QoS flow is first suspended or released. Furthermore, in the case where the network side indicates to suspend or release the first path among the plurality of paths corresponding to the QoS flow, the terminal device then suspends or releases the first path. Alternatively, in the case of transmitting an SDAP end marker PDU, the above-mentioned action of suspending or releasing the first path is performed.

In some embodiments, the configuration or change of the mapping relationship between the QoS flow and the path includes at least one of the following cases 1 to 2.

Case 1: The RRC configures an uplink QoS flow to DRB mapping rule for a QoS flow (configuring a UL QoS flow to DRB mapping rule for one QoS flow).

Case 2: RDI of each received downlink SDAP data PDU is set to 1 (each received DL SDAP data PDU with RDI set to 1).

The technical solutions according to the embodiments are applicable to cases where different data (such as different PDU sets, different encoded slices, and different frames) are mapped to the same QoS flow. The different data (such as different PDU sets) may be data with different importance, data with different associations, data with different dependencies, or data with different priorities. By the technical solutions according to the embodiments, a method for establishing or releasing a PDCP function in the case of configuring or changing the mapping between the QoS flow and the DRB is provided, such that the above-mentioned independent processing and/or joint processing of different data by the PDCP are supported.

Referring to FIG. 16, it illustrates a flowchart of a method for processing data according to some other embodiments of the present disclosure. The method includes the following processes:

In process 810, a first result is acquired by measuring and statistically analyzing the PDU set.

The applicable scenarios of the embodiments include at least one of the following scenarios 1 to 4.

Scenario 1: Applicable to QoS flows or services with QoS requirements at the granularity of the PDU set.

Scenario 2: In the case where indication or configuration is based on PDU-set delay budget (PSDB) and/or PDU-set error rate (PSER).

Scenario 3: In the case where the L2 (Layer 2) measurement and/or reporting at the granularity of the PDU set is activated or used.

Scenario 4: In the case where the PSDB and/or PSER measurement and/or reporting is activated or used.

In some embodiments, for PSER, the first result includes the PDU set loss rate, which indicates the ratio of the number of lost PDU sets to the total number of transmitted PDU sets. The measurement of the PDU set loss rate over the Uu interface between the terminal device and the access network device may be used for the observability of operation administration and maintenance (OAM) performance and/or the QoS verification for minimization of drive-tests (MDT).

In some embodiments, the measurement and statistical analysis of the PDU set loss rate conforms to at least one of the following cases 1 to 5.

Case 1: The PDU set loss rate is measured and statistically analyzed for the Uu interface.

Case 2: The PDU set loss rate is measured and statistically analyzed by the RLC layer.

Case 3: The PDU set loss rate is measured and statistically analyzed for each path (e.g., per DRB) of each terminal device (e.g., per UE).

Case 4: The PDU set loss rate is measured and statistically analyzed for the downlink.

Case 5: The PDU set loss rate is measured and statistically analyzed by the access network device.

In some embodiments, for the downlink of the Uu interface, the definition of the PDU set loss rate for each DRB of each UE is shown in Table 1 below.

TABLE 1
Definition for PDU set Uu Loss Rate in the DL per DRB per UE

| Definition | PDU set Uu Packet Loss Rate in the DL per DRB per UE. One PDU set has | |
|---|---|---|
| | one or more than one packet. One PDU set or part of a PDU set | |
| | corresponds to one RLC SDU. One packet corresponds to one RLC SDU. | |
| | The measurement is done separately per DRB. | |
| | Detailed Definition: | |
| | $M ( T , drbid ) = ⌊ \frac{Dloss ( T , drbid ) * 1000000}{N ( T , drbid ) + Dloss ( T , drbid )} ⌋ ,$ | Formula 1 |

where the explanation of each parameter in Formula 1 can be found in
Table 2 below.

NOTE 1:
PDU set Packet loss is expected to be upper bounded by the PSER (PDU-set error rate, as defined in TS 23.501) of the DRB. The statistical accuracy of an individual PDU set loss rate measurement result is dependent on how many PDU sets or packets have been received, and thus the time for the measurement.
NOTE 2:
The granularity for PDU set loss rate measurement is per DRB per UE.

TABLE 2
Parameter description for PDU set Uu Loss Rate in the DL per DRB per UE

| | |
|---|---|
| M(T, drbid) | PDU set Loss Rate in the DL per DRB per UE. Unit: number of lost PDU |
| | sets per transmitted PDU sets per DRB * 10⁶, Integer. |
| Dloss(T, drbid) | Number of DL PDU sets, of a data radio bearer with DRB Identity = drbid, |
| | for which at least a part has been transmitted over the air but not positively |
| | acknowledged, and it was decided during time period T that no more |
| | transmission attempts will be done. If transmission of a packet might |
| | continue in another cell, it shall not be included in this count. |
| | Note: a part means a part of or a packet of one PDU set, or, a restricted |
| | number of packets associated with one PDU set. |
| N(T, drbid) | Number of DL PDU sets, of a data radio bearer with DRB Identity = drbid, |
| | which has been transmitted over the air and positively acknowledged during |
| | time period T. |
| T | Time Period during which the measurement is performed, Unit: minutes. |
| drbid | The identity of the measured DRB. |

In some embodiments, for PSDB, the first result includes PDU set delay, wherein the PDU set delay indicates the average delay in processing the PDUs within the PDU set.

In some embodiments, the measurement and statistical analysis of the PDU set delay conforms to at least one of cases 1 to 4.

Case 1: The PDU set delay includes the delay in the access network part and/or the delay in the core network part.

Case 2: The PDU set delay is measured and statistically analyzed for each path of each terminal device.

Case 3: The PDU set delay is measured and statistically analyzed for the downlink.

Case 4: The PDU set delay is measured and statistically analyzed for the uplink.

Exemplarily, for the measurement and statistical analysis of the PDU set delay on the downlink, the measurement and statistical analysis are performed for each terminal device and each path.

Exemplarily, for the measurement and statistical analysis of the PDU set delay on the uplink, the measurement and statistical analysis are performed for each terminal device and each path.

In some embodiments, the measurement and statistical analysis of the PDU set delay on the uplink include at least one of Examples 1 to 5. Example 1 is applicable to a terminal device, and Examples 2 to 5 are applicable to an access network device.

Example 1: The PDU set delay is a queuing delay of the PDU set at the PDCP layer at the transmitter end, and the queuing delay is measured and statistically analyzed by the PDCP layer at the transmitter end.

In some embodiments, for the uplink, the terminal device measures the queuing delay of the PDU set at the PDCP layer. The purpose of the measurement is for QoS monitoring and/or QoS verification for MDT.

In some embodiments, the measurement configuration and/or reporting for the queuing delay includes at least one of the following items:
1. Corresponding delay configuration information is configured for the PDU set, wherein the delay configuration information is used to instruct to measure and/or report the queuing delay corresponding to the PDU set; exemplarily, delay value config of the PDU set is configured, with the delay value config being the delay configuration information.
2. The delay configuration information corresponding to the PDU set is included in the reporting configuration information; exemplarily, the delay value config of the PDU set is included in ReportConfigNR.
3. The reporting configuration information including the delay configuration information corresponding to the PDU set is included in the measurement configuration information; exemplarily, ReportConfigNR including the delay value config corresponding to the PDU set is included in MeasConfig.
4. The delay configuration information corresponding to the PDU set configuration indicates that the reporting type for the queuing delay is periodic reporting; exemplarily, the reporting type of the delay value config for the PDU set is periodic reporting, which may be further included in PeriodicalReportConfig.
5. The queuing delay corresponding to the PDU set is included in the measurement result for reporting; exemplarily, the delay value (queuing delay) of the PDU set is included in MeasResults for reporting.
6. The measurement result includes the queuing delay corresponding to PDU sets of one or more paths; exemplarily, MeasResults includes the delay value of the PDU set for one or more DRBs. For example:

```
  UL-PDCP-PduSetDelayValueResultList ::= SEQUENCE (SIZE
  (1..maxDRB)) OF
UL-PDCP-PduSetDelayValueResult
UL-PDCP-PduSetDelayValueResult ::= SEQUENCE {
```

| | |
|---|---|
| drb-Id-r16 | DRB-Identity, |
| averageDelay-r16 | INTEGER (0..10000), |

...
}

7. The delay configuration information corresponding to the PDU set includes the configuration information for one or more paths; exemplarily, the delay value config of the PDU set may include config for one or more DRBs. For example, the delay value config indicates the DRB IDs used by UE to provide results of UL PDCP PDU set Delay value per DRB measurement (the DRB IDs that UE uses to provide the measurement results of UL PDCP PDU set delay value for each DRB). For example:

UL-PduSetDelayValueConfig ::= SEQUENCE {
delay-DRBlist SEQUENCE (SIZE(1..maxDRB)) OF DRB-Identity
}

In some embodiments, the item 2 satisfies at least one of the following conditions:
2-1. The reporting configuration information has a corresponding reporting configuration identifier; exemplarily, ReportConfigNR has corresponding ReportConfigId.
2-2. The reporting configuration identifier corresponds to a measurement identifier; exemplarily, ReportConfigId corresponds to MeasId.
2-3. The measurement identifier is associated with the measurement result corresponding to the measurement configuration information; exemplarily, MeasId is associated with MeasResults for reporting the measurement result of MeasConfig.

In some embodiments, for the uplink, the definition of the average UL PDU set delay (i.e., the queuing delay) for each DRB of each UE is shown in Table 3 below.

TABLE 3
Definition for UL PDCP PDU set Average Delay per DRB per UE

| Definition | PDCP PDU set Delay in the UL per DRB. This measurement refers to PDCP | |
|---|---|---|
| | queuing delay for DRBs in the UE, which captures the delay from packet of | |
| | a PDU set or PDU set arrival at PDCP upper SAP until the UL grant to | |
| | transmit the packet of a PDU set or PDU set is available, which has included | |
| | the delay the UE gets resources granted (from sending SR/RACH to get the | |
| | first grant). The measurement is done separately per DRB. | |
| | Detailed Definition: | |
| | $M ( T , drbid ) = ⌊ \frac{{\sum }_{∀ i} tDeliv ( i , drbid ) - tArrival ( i , drbid )}{I ( T )} ⌋ ,$ | Formula 2 |
| | where the explanation of each parameter in Formula 2 can be | |
| | found in Table 4 below. | |

TABLE 4
Parameter description for UL PDCP PDU
set Average Delay per DRB per UE

| | |
|---|---|
| M(T, drbid) | PDCP average delay in the UL per DRB, averaged |
| | during time period T. Unit: 0.1 ms. |
| | PDCP average delay in the UL per DRB is 1 s |
| | if the actual value is larger than 1 s. |
| tArrival(i) | The point in time when the UL PDCP SDU of a PDU |
| | set i or PDU set i arrivals at PDCP upper SAP. |
| tDeliv(i) | The point in time when the UL MAC PDU k including |
| | the first part of UL PDCP SDU of a PDU set i or |
| | PDU set i is scheduled for transmission. |
| i | A UL PDCP SDU that is received by the PDCP during |
| | time period T. |
| I(T) | Total number of UL PDCP SDUs received during time |
| | period T. |
| T | Time Period during which the measurement is performed. |
| drbid | The identity of the measured DRB. |

Example 2: The PDU set delay is an air interface transmission delay of the PDU set, and the air interface transmission delay is measured and statistically analyzed by the MAC layer at the receiver end.

In some embodiments, for the UL, the air interface transmission delay of the PDU set is measured by the access network device at the MAC layer. The purpose of the measurement is for at least one of observability of OAM performance, QoS monitoring, and QoS verification for MDT.

In some embodiments, the measurement configuration and/or reporting for the air interface transmission delay includes at least one of the following items:
1. The air interface transmission delay is measured for each path of each terminal device.
2. The measurement is performed by the MAC layer.
3. The measurement is the granted transmission time for correspondingly transmitting a PDU set. The granted transmission time for correspondingly transmitting a PDU set refers to the average time (arithmetic mean) required to successfully receive a transport block within a UL transmission time specified in a scheduling grant for a PDU set.
4. The grant corresponding to the measurement corresponds to the first packet, the last packet, or all packets of the PDU set.

Example 3: The PDU set delay is a processing delay of the PDU set at the RLC layer at the receiver end, and the processing delay is measured and statistically analyzed by the RLC layer at the receiver end.

In some embodiments, for the UL, the access network device measures the processing delay of the PDU set at the RLC layer. The purpose of the measurement is for at least one of observability of OAM performance, QoS monitoring, and QoS verification for MDT. In some embodiments, the measurement is performed by the RLC layer.

In some embodiments, for the uplink, the definition of the average RLC PDU set delay for each DRB of each UE (i.e., the processing delay of the PDU set at the RLC layer at the receiver end) is shown in Table 5 below.

TABLE 5
Definition for Average RLC PDU set delay in the UL per DRB per UE

| Definition | Average RLC delay in the UL per DRB per UE. This measurement is | |
|---|---|---|
| | applicable for EN-DC and SA. This measurement refers to PDU set delay for | |
| | DRBs. For CU-UP and DU split scenario or DC scenario, this measurement | |
| | refers to the RLC delay on each DU or RAN node. This measurement | |
| | provides the average (arithmetic mean) time it takes from the RLC PDU | |
| | including the first part of an RLC SDU associated with a PDU set is received | |
| | to the RLC SDU associated with a PDU set is sent to PDCP or CU-UP for | |
| | split gNB. | |
| | Detailed Definition: | |
| | $M ( T , drbid ) = ⌊ \frac{{\sum }_{∀ i} tSent ( i , drbid ) - tReceiv ( i , drbid )}{I ( T )} ⌋ ,$ | Formula 3 |

where the explanation of each parameter in Formula 3 can be found in
Table 6 below.

TABLE 6
Parameter description for Average RLC
packet delay in the UL per DRB per UE

| | |
|---|---|
| M(T, drbid) | RLC delay in the UL per DRB per UE, averaged |
| | during time period T. Unit: 0.1 ms. |
| tReceiv(i, drbid) | The point in time when the UL RLC PDU |
| | including the first part of the UL RLC SDU |
| | associated with a PDU set i is received. |
| tSent(i, drbid) | The point in time when the UL RLC |
| | SDU associated with a PDU set |
| | i is sent to PDCP or CU-UP for split gNB. |
| i | A UL RLC SDU that is received by the |
| | RLC during time period T. |
| I(T) | Total number of UL RLC SDUs i. |
| T | Time Period during which the |
| | measurement is performed. |
| drbid | The identity of the measured DRB. |

Example 4: The PDU set delay is a reordering delay of the PDU set at the PDCP layer at the receiver end, and the reordering delay is measured and statistically analyzed by the PDCP layer at the receiver end.

In some embodiments, for the UL, the access network device measures the reordering delay of the PDU set at the PDCP layer. The purpose of the measurement is for at least one of observability of OAM performance, QoS monitoring, and QoS verification for MDT. In some embodiments, the measurement is performed by the PDCP layer.

In some embodiments, for the uplink, the definition of the average PDCP reordering delay for each DRB of each UE (i.e., the reordering delay of the PDU set at the PDCP layer at the receiver end) is shown in Table 7 below.

TABLE 7
Definition for Average PDCP re-ordering delay in the UL per DRB per UE

| Definition | Average PDCP re-ordering delay in the UL per DRB per UE. This | |
|---|---|---|
| | measurement is applicable for EN-DC and SA. This measurement refers to | |
| | PDU set delay for DRBs. This measurement provides the average (arithmetic | |
| | mean) time it takes from the point a PDCP PDU of a PDU set is received to | |
| | the PDCP SDU is sent to upper SAP. | |
| | Detailed Definition: | |
| | $M ( T , drbid ) = ⌊ \frac{{\sum }_{∀ i} tSent ( i , drbid ) - tReceiv ( i , drbid )}{I ( T )} ⌋ ,$ | Formula 4 |

where the explanation of each parameter in Formula 4 can be found in
Table 8 below.

TABLE 8
Parameter description for Average PDCP re-
ordering delay in the UL per DRB per UE

| | |
|---|---|
| M(T, drbid) | PDCP re-ordering delay in the UL per DRB per UE, |
| | averaged during time period T. Unit: 0.1 ms. |
| tReceiv(i, drbid) | The point in time when the UL PDCP PDU of a |
| | PDU set including the UL PDCP SDU i is received. |
| tSent(i, drbid) | The point in time when the UL PDCP SDU |
| | i is sent to upper SAP. |
| i | A UL PDCP SDU that is received by the |
| | PDCP during time period T. |
| I(T) | Total number of UL PDCP SDUs received |
| | during time period T. |
| T | Time Period during which the |
| | measurement is performed. |
| drbid | The identity of the measured DRB. |

Example 5: The PDU set delay for the uplink over the F1-U interface uses the same measurement criteria as the PDU set delay for the downlink over the F1-U interface.

The technical solutions according to the embodiments achieve measurement and statistical analysis at the granularity of the PDU set, which may be used for QoS monitoring and/or QoS verification at the granularity of the PDU set.

In some embodiments, the fact that energy consumption has become an important component of the operational costs for operators has been taken into account. According to reports from relevant agencies, the energy costs of mobile networks account for about 23% of the total costs for operators. Most of the energy consumption comes from the radio access network, particularly the active antenna unit (AAU), while data centers and fiber transmission only account for a small portion. Power consumption includes a dynamic part (e.g., consumption during data transmission/reception) and a static part (e.g., consumption to maintain the necessary operation of radio access devices even when no data transmission/reception is ongoing).

Therefore, researches on energy saving for networks and UEs should not only evaluate the potential benefits from network energy consumption but also evaluate and balance the impacts on network and user performance. For example, such researches should not significantly affect some key performance indicators (KPIs), such as spectral efficiency, capacity, user perceived throughput (UPT), latency, UE power consumption, complexity, handover performance, call drop rate, and initial access performance.

In the related art, some solutions mainly focus on UE energy saving, but there is limited consideration for network energy saving.

In some embodiments, in the case where the access network device or cell is in a first state, the terminal device performs signal or data transmission or reception based on the indication from the access network device.

In some embodiments, the first state includes at least one of an off state and an energy-saving state. The off state refers to a state where no service is provided, or a power-off state.

In some embodiments, the indication is transmitted by the access network device to the terminal device over an RRC message, DCI, or a MAC CE. The RRC message is system information or a dedicated RRC message.

In some embodiments, the indication information is cell specific, user equipment (UE) specific, or terminal group (UE group) common.

In some embodiments, in the case of UE-group common, the indication indicates the UE-group identifier and/or cell identifier.

In some embodiments, in the case of cell-specific, the indication indicates the cell identifier.

In some embodiments, in the case of UE-specific, the indication carries the UE identifier or uses a UE-specific RNTI (e.g., C-RNTI).

In some embodiments, the indication information indicates one of the following signalings (which are only examples and may be in other forms to indicate specifically which signalings or channels are to be transmitted or not transmitted).
1. Common signaling, such as at least one of SSB, SIB, or cell specific RS.
2. Common signaling+UE specific information, wherein the above UE specific information includes RS and/or data.
3. Common signaling+UE specific RS.
4. Common signaling+UE specific data transmission.
5. UE specific information.
6. Common signaling+UE specific information+RACH.
7. Common signaling+UE specific RS+RACH.
8. Common signaling+UE specific data transmission+RACH.
9. UE specific information+RACH.
10. Common signaling+RACH.

In some embodiments, based on the indication information, the terminal device determines which signals or data can be transmitted, and/or transmits the indicated signal or data.

In some embodiments, the access network device transmits indication information to the terminal device, wherein the indication information is used to instruct or configure the terminal device to report assistance information. In some embodiments, the indication information is an SIB message. In some embodiments, the indication information is cell specific or UE-group common. In some embodiments, the UE assistance information is used to report energy-saving related information. Specifically, at least one of the following items is included:
1. In the case of UE-group common, the above indication information indicates the UE-group identifier and/or cell identifier.
2. In the case of cell-specific, the above indication information indicates the cell identifier.
3. The UE assistance information reporting indication or configuration includes at least one of reporting type, reporting prohibition duration or timer, or reporting enable/disable indication. The reporting type indicates the content of the assistance information reported by the UE (e.g., service information, recommended configuration information, mobility information, and UE buffer information).
4. The UE reports assistance information using a UL RRC message based on the UE assistance information reporting indication or configuration indicated by the indication information. In some embodiments, the UL RRC message is UE assistance information (such as a UEAssistanceInformation message).
5. The UE reports the energy-saving assistance information and/or starts the energy-saving assistance information reporting timer (in some embodiments, the energy-saving assistance information is only reported in the case where the timer is not running) in at least one of the following cases:

In the case where the UE has not transmitted the relevant assistance information (e.g., a UEAssistanceInformation message) since being configured to report; or in the case where the current value is different from the value indicated in the last transmission of the relevant assistance information (e.g., a UEAssistanceInformation message).
6. The energy-saving information includes at least one of service information, recommended configuration information, mobility information, UE buffer information, or the like.

Solution 3: In the case where the UE is one that supports network energy saving or the access network device instructs the UE to perform the UE energy-saving operation, under the condition of BWP switching or BWP deactivation, the UE suspends the CG (configured grant) type 2 and/or SPS associated with the BWP before switching or the deactivated BWP or inactive BWP. In some embodiments, on the activated BWP or the BWP after switching, the UE performs reporting or feedback for the BWP before switching or the deactivated BWP or inactive BWP, such as reporting the confirmation MAC CE and/or multiple entry configured grant confirmation MAC CE for the BWP before switching or the deactivated BWP or inactive BWP.

The following is an apparatus embodiment of the present disclosure that may be configured to implement the method embodiments of the present disclosure. For details that are not disclosed in the apparatus embodiment of the present disclosure, reference is made to the method embodiments of the present disclosure.

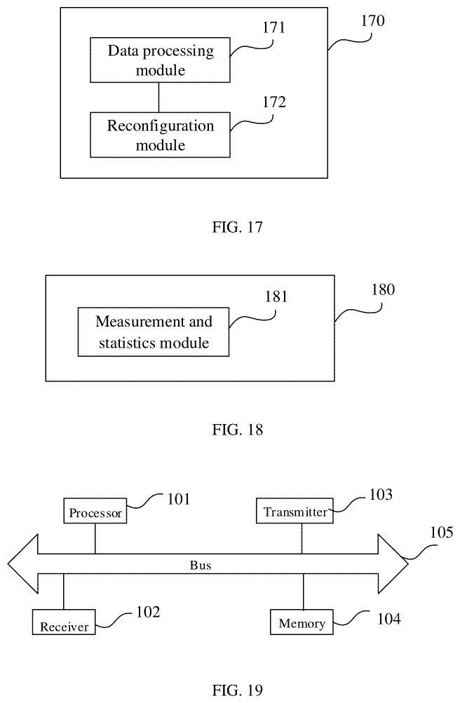

FIG. 17 illustrates a block diagram of an apparatus for processing data according to some embodiments of the present disclosure. The apparatus has functions for implementing the above method examples, and the functions may be implemented by hardware or by executing corresponding software on hardware. The apparatus may be a network device or may be provided in a network device. As shown in FIG. 17, the apparatus 170 includes a data processing module 171.

The data processing module 171 is configured to independently process and/or jointly process different data corresponding to the same QoS flow.

In some embodiments, the different data corresponds to different paths.

In some embodiments, in the case where the network device is the transmitter end, the independent processing includes at least one of:
routing the different data to different paths;
identifying the different data; or
using different first functions for the different data.

In some embodiments, the transmitter end is the SDAP layer, and routing the different data to the different paths includes: routing the different data to different PDCP entities; or routing the different data to different DRBs.

In some embodiments, the transmitter end is the PDCP layer, and routing the different data to the different paths includes: routing the different data to different RLC entities; or routing the different data to different logical channels.

In some embodiments, identifying the different data includes at least one of:
identifying the different data based on the PDU set corresponding to the data;
identifying the different data based on the start identifier and/or end identifier of the PDU set; or
identifying the different data based on the attribute of the data, wherein the attribute includes at least one of a type, an importance, an association, a priority, or a dependency.

In some embodiments, in the case where the network device is the transmitter end, the joint processing includes at least one of: numbering the different data using a unified SN; or using a unified first function for the different data.

In some embodiments, in the case where the network device is the receiver end, the independent processing includes at least one of: receiving the different data from different paths; or using different second functions for the different data.

In some embodiments, the receiver end is the SDAP layer, and receiving the different data from the different paths includes: receiving the different data from different PDCP entities; or receiving the different data from different DRBs.

In some embodiments, the receiver end is the PDCP layer, and receiving the different data from the different paths includes: receiving the different data from different RLC entities; or receiving the different data from different logical channels.

In some embodiments, in the case where the network device is the receiver end, the joint processing includes at least one of: reordering the different data based on the unified SN; or using a unified second function for the different data.

In some embodiments, the joint processing includes at least one of: the joint processing for the different data is a joint processing performed between protocol layers or entities; or the joint processing between protocol layers or entities is performed for data of the different data routed to different paths.

In some embodiments, the protocol layer or entity is a PDCP protocol layer or PDCP entity; or the protocol layer or entity is a joint protocol layer or joint entity corresponding to the PDCP protocol layer or PDCP entity.

In some embodiments, the joint processing is performed by the transmitter end and/or the receiver end.

In some embodiments, in the case where the network device is the transmitter end, as shown in FIG. 17, the apparatus 170 further includes a reconfiguration module 172.

The reconfiguration module 172 is configured to: in the case that a first event is configured or satisfied, reconfigure the PDCP layer or PDCP entity, and establish the first function for at least one path; and/or reconfigure the joint PDCP or joint processing entity, and establish the first function for at least one path; and/or configured to: in the case that the first event is deconfigured, released, or not satisfied, reconfigure the PDCP entity of the PDCP layer, and suspend or release the first function for at least one path; and/or reconfigure the joint PDCP or joint processing entity, and suspend or release the first function for at least one path.

Additionally/alternatively, the reconfiguration module 172 is configured to: in the case that a first event is configured or satisfied, reconfigure the PDCP layer at the transmitter end, and/or reconfigure the protocol layer or entity of joint processing; and/or in the case that the first event is deconfigured, released, or not satisfied, deconfigure or suspend processing of the PDCP layer at the transmitter end, and/or deconfigure or suspend processing of the protocol layer or entity of joint processing.

In some embodiments, the PDCP layer is associated with a plurality of different RLC entities, wherein the plurality of different RLC entities correspond to a plurality of different paths; or the PDCP layer is associated with a plurality of different RLC entities, wherein each of the plurality of different RLC entity corresponds to one path. The at least one path includes all of the plurality of different paths or part of the plurality of different paths.

In some embodiments, the data processing module 171 is further configured to perform, in the case that the mapping relationship between the QoS flow and the path is configured or changed and the first event is configured or satisfied, at least one of:
suspending or releasing a first path among a plurality of paths corresponding to the QoS flow;
suspending or releasing a first function of a first path among the plurality of paths corresponding to the QoS flow;
suspending or releasing a PDCP entity corresponding to a first path among the plurality of paths corresponding to the QoS flow;
suspending or releasing an RLC entity corresponding to a first path among the plurality of paths corresponding to the QoS flow;
resetting a MAC entity corresponding to a first path among the plurality of paths corresponding to the QoS flow;
restoring or establishing a second path for the QoS flow;
restoring or establishing a first function of a second path for the QoS flow;
restoring or establishing a PDCP entity corresponding to a second path for the QoS flow;
restoring or establishing an RLC entity corresponding to a second path for the QoS flow; or
configuring a MAC entity corresponding to a second path for the QoS flow.

In some embodiments, the first path is a default path, or a path determined based on the stored mapping relationship between the QoS flow and the path; and/or the second path is a changed path determined based on the configured, updated, or indicated mapping relationship between the QoS flow and the path.

In some embodiments, the first path includes all or part of the plurality of paths corresponding to the QoS flow; and/or the second path includes all or part of the plurality of paths corresponding to the QoS flow.

In some embodiments, the first event includes at least one of the following:

One QoS flow corresponds to a plurality of paths, or a specific QoS flow corresponds to a plurality of paths.

Different data corresponding to a QoS flow are configured for independent processing and/or joint processing.

A plurality of paths are associated with one PDCP entity, and different paths correspond to different identifiers, where the identifiers include at least one of: special identifiers, extended reality (XR) identifiers, or differentiated processing identifiers.

A plurality of PDCP layers or entities are associated with a protocol layer or entity of joint processing.

A PDCP layer or entity is associated with a plurality of different RLC entities, and the PDCP layer is associated with a target path, where the target path includes at least one of the following: a path with a special identifier, a path with an XR identifier, and a path with a differentiated processing identifier.

A PDCP layer or entity is associated with a plurality of different RLC entities, and the different RLC entities correspond to different paths.

A PDCP layer or entity is associated with a plurality of different RLC entities, and the PDCP layer differentiates the processing of the different data for the different RLC entities.

In some embodiments, the joint processing is targeted at a plurality of different PDCP entities, and the different data corresponds to the different PDCP entities; or the joint PDCP layer or joint PDCP entity corresponds to a plurality of different PDCP entities, and the different data corresponds to the different PDCP entities.

In some embodiments, the different PDCP entities have a binding relationship or a joint processing relationship.

In some embodiments, independent processing and/or joint processing of the different data is performed in the same PDCP entity.

In some embodiments, the PDCP entity reuses the DAPS architecture.

In some embodiments, the first function includes at least one of: an integrity protection function, an encryption function, or a header compression function.

In some embodiments, the second function includes at least one of: an integrity authentication function, a decryption function, or a decompression function.

In some embodiments, the path is an RB.

In some embodiments, the different data corresponds to different PDU sets, or the different data corresponds to PDU sets with different attributes.

In some embodiments, the different data have different attributes, wherein the attributes include at least one of: a type, an importance, an association, a priority, and a dependency.

Referring to FIG. 18, it illustrates a block diagram of an apparatus for processing data according to some other embodiments of the present disclosure. The apparatus has functions for implementing the above method examples, and the functions may be implemented by hardware or by executing corresponding software on hardware. The apparatus may be a network device or may be provided in a network device. As shown in FIG. 18, the apparatus 180 includes: a measurement and statistics module 181.

The measurement and statistics module 181 is configured to acquire a first result by measuring and statistically analyzing a PDU set.

In some embodiments, the first result includes a PDU set loss rate, wherein the PDU set loss rate indicates the ratio of the number of lost PDU sets to the total number of transmitted PDU sets.

In some embodiments, the measurement and statistical analysis of the PDU set loss rate conforms to at least one of the following cases.

The PDU set loss rate is measured and statistically analyzed for a Uu interface.

The PDU set loss rate is measured and statistically analyzed by the radio link control (RLC) layer.

The PDU set loss rate is measured and statistically analyzed for each path of each terminal device.

The PDU set loss rate is measured and statistically analyzed for the downlink.

The PDU set loss rate is measured and statistically analyzed by the access network device.

In some embodiments, the first result includes a PDU set delay, wherein the PDU set delay indicates the average delay in processing the PDUs within the PDU set.

In some embodiments, the measurement and statistical analysis of the PDU set delay conforms to at least one of the following cases.

The PDU set delay includes the delay in the access network part and/or the delay in the core network part.

The PDU set delay is measured and statistically analyzed for each path of each terminal device.

The PDU set delay is measured and statistically analyzed for the downlink.

The PDU set delay is measured and statistically analyzed for the uplink.

In some embodiments, the PDU set delay is a queuing delay of the PDU set at the Packet Data Convergence Protocol (PDCP) layer at the transmitter end, and the queuing delay is measured and statistically analyzed by the PDCP layer at the transmitter end.

In some embodiments, the measurement configuration and/or reporting for the queuing delay includes at least one of the following items.

Corresponding delay configuration information is configured for the PDU set, wherein the delay configuration information is used to instruct to measure and/or report the queuing delay corresponding to the PDU set.

The delay configuration information corresponding to the PDU set is included in the reporting configuration information.

The reporting configuration information including the delay configuration information corresponding to the PDU set is included in the measurement configuration information.

The delay configuration information corresponding to the PDU set configuration indicates that the reporting type for the queuing delay is periodic reporting.

The queuing delay corresponding to the PDU set is included in the measurement result for reporting.

The measurement result includes the queuing delay corresponding to PDU sets of one or more paths.

The delay configuration information corresponding to the PDU set includes the configuration information for one or more paths.

In some embodiments, the method satisfies at least one of the following items.

The reporting configuration information has a corresponding reporting configuration identifier.

The reporting configuration identifier corresponds to a measurement identifier.

The measurement identifier is associated with the measurement result corresponding to the measurement configuration information.

In some embodiments, the PDU set delay is an air interface transmission delay of the PDU set, wherein the air interface transmission delay is measured and statistically analyzed by the MAC layer at the receiver end.

In some embodiments, the PDU set delay is a processing delay of the PDU set at the RLC layer at the receiver end, and the processing delay is measured and statistically analyzed by the RLC layer at the receiver end.

In some embodiments, the PDU set delay is a reordering delay of the PDU set at the PDCP layer at the receiver end, and the reordering delay is measured and statistically analyzed by the PDCP layer at the receiver end.

In some embodiments, the PDU set delay for the uplink over the F1-U interface uses the same measurement criteria as the PDU set delay for the downlink over the F1-U interface.

It should be noted that, in the case that the apparatus according to the above embodiments implements the functions thereof, the division of the functional modules is merely exemplary. In practice, the above functions may be assigned to different functional modules according to actual needs, i.e., the internal structure of the device may be divided into different functional modules, so as to implement all or a part of the above functions.

With regard to the apparatus in the above embodiments, the specific manner in which each module performs the operation has been described in detail in the embodiments related to the method and is not be described in detail herein.

FIG. 19 illustrates a schematic structural diagram of a communication device (a terminal device or an access network device) according to some exemplary embodiments of the present disclosure. The communication device includes: a processor 101, a receiver 102, a transmitter 103, a memory 104, and a bus 105.

The processor 101 includes one or more processing cores. The processor 101 runs various functional applications and performs information processing by running software programs and modules. The receiver 102 and the transmitter 103 may be implemented as one communication assembly, which may be a communication chip. The memory 104 is connected to the processor 101 via the bus 105. The memory 104 may be configured to store one or more computer programs. The processor 101, when loading and running the one or more computer programs, is caused to perform the various processes in the above method embodiments.

In addition, the memory 104 may be implemented using any type of volatile or non-volatile storage device or a combination thereof. The volatile or non-volatile storage device includes but not limited to: a magnetic or optical disk, an electrically-erasable programmable read-only memory (EEPROM), an erasable programmable read-only memory (EPROM), a static random access memory (SRAM), a read-only memory (ROM), a magnetic memory, a flash memory, or a programmable read-only memory (PROM).

In some embodiments, a computer-readable storage medium is further provided. The storage medium stores one or more computer programs. The one or more computer programs, when loaded and run by a processor, cause the processor to perform the various processes in the above method embodiments.

In some embodiments, a chip is further provided. The chip includes one or more programmable logic circuits and/or one or more program instructions. The chip, when running, is caused to perform the various processes in the above method embodiments.

In some embodiments, a computer program product is further provided. The computer program product includes one or more computer instructions stored in a computer-readable storage medium. The one or more computer instructions, when read from the computer-readable storage medium and executed by a processor, cause the processor to perform the various processes in the above method embodiments.

It should be understood that the term “indication” mentioned in the embodiments of the present disclosure is a direct indication, an indirect indication, or an indication that there is an association relationship. For example, “A indicates B” may mean that A indicates B directly, e.g., B may be acquired through A; or that A indicates B indirectly, e.g., A indicates C through which B may be acquired; or that an association relationship is present between A and B.

In the description of the embodiments of the present disclosure, the term “correspond” indicates a direct or indirect corresponding relationship between two items, or indicates an association relationship between the two. It may also indicate relationships such as indicating and being indicated, configuring and being configured, or the like.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, the term “predefined” refers to “defined” in a protocol.

In some embodiments of the present disclosure, the term “protocol” refers to a standard protocol in the field of communication, and for example, may include an LTE protocol, an NR protocol, and related protocols applicable to future communication systems, which is not limited in the present disclosure.

The mentioned term “a plurality of” herein means two or more. The term “and/or” describes the association relationship of the associated objects, and indicates that three relationships may be present. For example, the phrase “A and/or B” means (A), (B), or (A and B). The character “/” generally indicates an “or” relationship between the associated objects.

The term “less than” mentioned herein may be understood as less than or may also be understood as less than or equal to; the term “larger than” mentioned herein may be understood as larger than or may also be understood as larger than or equal to.

In addition, serial numbers of the processes described herein only show an exemplary possible execution sequence among the processes, and in some other embodiments, the processes may also be executed out of the numbering sequence, for example, two processes with different serial numbers are executed simultaneously, or two processes with different serial numbers are executed in a reverse order to the illustrated sequence, which is not limited in the present disclosure.

In addition, the embodiments provided herein may be combined in any manner to form new embodiments, all of which fall within the protection scope of the present disclosure.

Those skilled in the art should appreciate that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium. The communication medium includes any medium that facilitates the transfer of a computer program from one place to another. The storage medium may be any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for processing data, comprising:
independently processing and/or jointly processing different data corresponding to a same quality of service (QOS) flow.

2. The method according to claim 1, wherein the different data corresponds to different paths.

3. The method according to claim 1, wherein the method is applicable to a transmitter end, and there is at least one of:
the independent processing comprises at least one of: routing the different data to different paths; identifying the different data; or using different first functions for the different data; or
the joint processing comprises at least one of: numbering the different data using a unified sequence number (SN); or using a unified first function for the different data.

4. The method according to claim 3, wherein
the transmitter end is a Service Data Adaptation Protocol (SDAP) layer, and routing the different data to the different paths comprises: routing the different data to different Packet Data Convergence Protocol (PDCP) entities; or routing the different data to different data radio bearers (DRBs); or
the transmitter end is a PDCP layer, and routing the different data to the different paths comprises: routing the different data to different radio link control (RLC) entities; or routing the different data to different logical channels.

5. The method according to claim 3, wherein identifying the different data comprises at least one of:
identifying the different data based on a protocol data unit (PDU) set corresponding to the data;
identifying the different data based on a start identifier and/or an end identifier of a PDU set; or
identifying the different data based on an attribute of the data, wherein the attribute comprises at least one of a type, an importance, an association, a priority, or a dependency.

6. The method according to claim 1, wherein the method is applicable to a receiver end, and there is at least one of:
the independent processing comprises at least one of: receiving the different data from different paths; or using different second functions for the different data; or
the joint processing comprises at least one of: reordering the different data based on a unified sequence number (SN); or using a unified second function for the different data.

7. The method according to claim 6, wherein
the receiver end is a Service Data Adaptation Protocol (SDAP) layer, and receiving the different data from the different paths comprises: receiving the different data from different Packet Data Convergence Protocol (PDCP) entities; or receiving the different data from different data radio bearers (DRBs); or
the receiver end is a Packet Data Convergence Protocol (PDCP) layer, and receiving the different data from the different paths comprises: receiving the different data from different radio link control (RLC) entities; or receiving the different data from different logical channels.

8. A communication device, comprising a processor and a memory storing one or more computer programs, wherein the processor, when loading and running the one or more computer programs, is caused to perform:
independently processing and/or jointly processing different data corresponding to a same quality of service (QOS) flow.

9. The communication device according to claim 8, wherein the joint processing comprises at least one of:
the joint processing for the different data being a joint processing performed between protocol layers or entities; or
the joint processing between protocol layers or entities being performed for data of the different data routed to different paths.

10. The communication device according to claim 9, wherein
the protocol layer or entity is a Packet Data Convergence Protocol (PDCP) layer or PDCP entity; or
the protocol layer or entity is a joint protocol layer or joint entity corresponding to a Packet Data Convergence Protocol (PDCP) layer or PDCP entity.

11. The communication device according to claim 9, wherein the joint processing is performed by at least one of a transmitter end or a receiver end.

12. The communication device according to claim 8, wherein the communication device is a transmitter end, and the processor, when loading and running the one or more computer programs, is caused to further perform at least one of:
in a case that a first event is configured or satisfied, reconfiguring a Packet Data Convergence Protocol (PDCP) layer or a PDCP entity, and establishing a first function for at least one path; and/or reconfiguring a joint PDCP or joint processing entity, and establishing a first function for at least one path; or
in a case that a first event is deconfigured, released, or not satisfied, reconfiguring a PDCP entity of a PDCP layer, and suspending or releasing a first function for at least one path; and/or
reconfiguring a joint PDCP or joint processing entity, and suspending or releasing a first function for at least one path.

13. The communication device according to claim 8, wherein there is at least one of:
in a case that a first event is configured or satisfied, a transmitter end Packet Data Convergence Protocol (PDCP) layer is reconfigured, and/or a protocol layer or entity of joint processing is reconfigured; or
in a case that a first event is deconfigured, released, or not satisfied, a PDCP layer at the transmitter end is deconfigured or processing thereof is suspended, and/or a protocol layer or entity of joint processing is deconfigured or processing thereof is suspended.

14. A communication device, comprising a processor and a memory storing one or more computer programs, wherein the processor, when loading and running the one or more computer programs, is caused to perform:
acquiring a first result by measuring and statistically analyzing a protocol data unit (PDU) set.

15. The communication device according to claim 14, wherein there is at least one of:
the first result comprises a PDU set loss rate, wherein the PDU set loss rate indicates a ratio of a number of lost PDU sets to a total number of transmitted PDU sets; or
the first result comprises a PDU set delay, wherein the PDU set delay indicates an average delay in processing PDUs within the PDU set.

16. The communication device according to claim 15, wherein the measurement and statistical analysis of the PDU set loss rate conforms to at least one of:
the PDU set loss rate being measured and statistically analyzed for a Uu interface;
the PDU set loss rate being measured and statistically analyzed by a radio link control (RLC) layer;
the PDU set loss rate being measured and statistically analyzed for each path of each terminal device;
the PDU set loss rate being measured and statistically analyzed for a downlink; or
the PDU set loss rate being measured and statistically analyzed by an access network device.

17. The communication device according to claim 15, wherein the measurement and statistical analysis of the PDU set delay conforms to at least one of:
the PDU set delay comprising a delay in an access network part and/or a delay in a core network part;
the PDU set delay being measured and statistically analyzed for each path of each terminal device;
the PDU set delay being measured and statistically analyzed for a downlink; or
the PDU set delay being measured and statistically analyzed for an uplink.

18. The communication device according to 15, wherein there is one of:
the PDU set delay is a queuing delay of the PDU set at a Packet Data Convergence Protocol (PDCP) layer at a transmitter end, wherein the queuing delay is measured and statistically analyzed by the PDCP layer at the transmitter end;
the PDU set delay is an air interface transmission delay of the PDU set, wherein the air interface transmission delay is measured and statistically analyzed by a medium access control (MAC) layer at a receiver end;
the PDU set delay is a processing delay of the PDU set at a radio link control (RLC) layer at a receiver end, wherein the processing delay is measured and statistically analyzed by the RLC layer at the receiver end;
the PDU set delay is a reordering delay of the PDU set at a Packet Data Convergence Protocol (PDCP) layer at a receiver end, wherein the reordering delay is measured and statistically analyzed by the PDCP layer at the receiver end; or
the PDU set delay for an uplink over an F1-U interface uses same measurement criteria as the PDU set delay for a downlink over the F1-U interface.

19. The communication device according to claim 18, wherein measurement configuration and/or reporting for the queuing delay comprises at least one of:
configuring corresponding delay configuration information for the PDU set, wherein the delay configuration information is used to instruct to measure and/or report the queuing delay corresponding to the PDU set;
containing the delay configuration information corresponding to the PDU set in reporting configuration information;
containing reporting configuration information in measurement configuration information, wherein the reporting configuration information comprises delay configuration information corresponding to the PDU set;
delay configuration information corresponding to the PDU set configuration indicating that a reporting type for the queuing delay is periodic reporting;
containing the queuing delay corresponding to the PDU set in a measurement result for reporting;
measurement result comprising queuing delay corresponding to PDU sets of one or more paths; or
delay configuration information corresponding to the PDU set comprising configuration information for one or more paths.

20. The communication device according to claim 19, wherein there is at least one of:
the reporting configuration information having a corresponding reporting configuration identifier;
a reporting configuration identifier corresponding to a measurement identifier; or
a measurement identifier being associated with a measurement result corresponding to the measurement configuration information.
